(19) United States
(12) Patent Application Publication
(10) Pub. No.: US 2026/0354486 A1
(43) Pub. Date: Nov. 12, 2026

(54) Aerosol Generation Device Power Usage Control

(71) Applicant: JT International SA, Geneva (CH)

(72) Inventor: Grzegorz Aleksander Pilatowicz, Grens (CH)

(73) Assignee: JT International SA, Geneva (CH)

(21) Appl. No.: 19/116,129

(22) PCT Filed: Dec. 20, 2023
(86) PCT No.: PCT/EP2023/087034

§ 371 Date: Mar. 27, 2025

(30) Foreign Application Priority Data
Dec. 20, 2022 (EP) 22215004.7

(51) Int. Cl. A24F 40/53; A24F 40/57; A24F 40/65; H05B 1/02

(52) U.S. Cl. CPC A24F 40/53; A24F 40/57; A24F 40/65; H05B 1/0202

(57) ABSTRACT

An aerosol generation device comprising a battery, a controller and a battery monitor. The controller is configured to measure an energy level of the battery using the battery monitor and calculate a number, a, of aerosolisation sessions that can be powered for a first aerosolisation session heating profile. The controller is configured to receive an instruction to enter an eco-mode in which a+b aerosolisation sessions can be performed, and enter the eco-mode, incrementally modifying the aerosolisation session heating profile and recalculating the number of aerosolisation sessions that can be powered based upon the measured energy level of the battery until a second aerosolisation session heating profile is determined at which a+b aerosolisation sessions can be performed. The controller is configured to control the aerosol generation device to perform an aerosolisation session using the second aerosolisation session heating profile.

### FIELD OF THE INVENTION

The present invention relates to aerosol generation devices, and more specifically aerosol generation device power usage control.

### BACKGROUND

Aerosol generation devices such as electronic cigarettes and other aerosol inhalers or vaporisation devices are becoming increasingly popular consumer products.

Heating devices for vaporisation or aerosolisation are known in the art. Such devices typically include a heating chamber and heater. In operation, an operator inserts the product to be aerosolised or vaporised into the heating chamber. The product is then heated with an electronic heater to vaporise the constituents of the product for the operator to inhale. In some examples, the product is a tobacco product similar to a traditional cigarette. Such devices are sometimes referred to as “heat not burn” devices in that the product is heated to the point of aerosolisation, without being combusted.

Problems faced by known aerosol generation devices include providing effective control of power usage, as well as improving usability.

### SUMMARY OF INVENTION

In a first aspect, there is provided an aerosol generation device comprising a battery, a controller and a battery monitor, wherein the controller is configured to:
control a power flow from the battery to a heater of the aerosol generation device to perform an nth aerosolisation session, wherein n is an integer greater than or equal to 1;
acquire aerosolisation session characteristics of the nth aerosolisation session measured using the battery monitor;
access a relationship of energy use per aerosolisation session as a function of number of aerosolisation sessions performed, and update the relationship based upon the acquired aerosolisation session characteristics of the nth aerosolisation session, wherein the relationship is stored in storage accessible by the controller;
determine a number of aerosolisation sessions that can be powered after the nth aerosolisation session based upon the updated relationship of energy use per aerosolisation session as a function of number of aerosolisation sessions performed and an energy level of the battery; and
control the aerosol generation device to output the number of aerosolisation sessions that can be powered after the nth session.

Aerosol generation devices can be configured to indicate the state-of-charge of the battery, in a similar manner to a smartphone. However, this information can be non-intuitive and confusing to the user when considering how many aerosolisation sessions can be performed. It may not be clear to the user how many aerosolisation sessions can be powered for a given state-of-charge. In traditional smoking, a smoker can look in the cigarette packet and determine the number of cigarettes available to smoke. For an aerosol generation device that indicates the state-of-charge of the battery, it is not clear to the operator as to how many aerosolisation sessions can be performed. It is therefore necessary to provide a technical solution that can be used to indicate the number of remaining aerosolisation sessions that can be powered by the battery of an aerosol generation device. The first aspect addresses this challenge through the provision of a process for determining the number of aerosolisation sessions that can be powered by the battery, and outputting this information. Moreover, this process accounts for real-time changes to the battery and aerosol generation device so that an accurate determination of the number of aerosolisation sessions that can be powered is achieved.

Preferably, the battery monitor comprises a voltage measurement module configured to measure a voltage of the battery for an aerosolisation session, and the acquired aerosolisation session characteristics of the nth aerosolisation session comprise a battery voltage of the nth aerosolisation session measured by the voltage measurement module.

In this way, the battery voltage can be used to determine the number of aerosolisation sessions that can be powered after the nth aerosolisation session.

Preferably, the battery monitor comprises a current measurement module configured to measure a current output by the battery in an aerosolisation session, and the acquired aerosolisation session characteristics of the nth aerosolisation session comprise a current output by the battery in the nth aerosolisation session measured by the current measurement module.

In this way, the current output of the battery can be used to determine the number of aerosolisation sessions that can be powered after the nth aerosolisation session.

Preferably, the battery monitor comprises an ambient temperature measurement module configured to measure an ambient temperature proximal to the aerosol generation device during an aerosolisation session, and the aerosolisation session characteristics of the nth aerosolisation session comprise an ambient temperature measured in the nth aerosolisation session by the ambient temperature measurement module.

In this way, the temperature proximal to the aerosol generation device can be used in the determination of the number of aerosolisation sessions that can be powered after the nth aerosolisation session. Extreme high and low temperatures can affect the battery performance, and so factoring the temperature into the calculation improves the accuracy of the determination of the number of aerosolisation sessions that can be powered after the nth aerosolisation session.

Preferably, the nth aerosolisation session is a most recently completed aerosolisation session.

In this way, the determination of number of aerosolisation sessions that can be powered can be updated in response to the most recently completed aerosolisation session. This ensures that the operator is continually presented with the most useful information regarding the battery level of the device.

Preferably, the relationship of energy use per aerosolisation session as a function of number of aerosolisation sessions performed comprises predetermined values of energy use per aerosolisation session for a series of aerosolisation sessions performed consecutively.

In this way, predetermined and prestored data relating to the energy use per aerosolisation session as a function of number of aerosolisation sessions performed can be used for an initial determination of the number of aerosolisation sessions that can be powered.

Preferably, the controller is configured to update the relationship of energy use per session as a function of number of aerosolisation sessions performed by updating an energy use value of the nth aerosolisation session determined from the aerosolisation session characteristics, and applying a fitting algorithm to the relationship of energy use per session as a function of number of aerosolisation sessions performed including the updated energy use value of the nth aerosolisation session.

Preferably, the controller is configured to determine the number of aerosolisation sessions that can be powered after the nth session by calculating a number of future sessions after nth session that can be powered based upon the updated relationship of energy use per session as function of number of aerosolisation sessions performed for future aerosolisation sessions after nth session and the energy level of battery.

In this way, real-time measurements of the aerosolisation session characteristics are factored into the determination of the number of aerosolisation sessions that can be powered. As such, the determined number of aerosolisation sessions that can be powered accurately reflects the current operating conditions of the aerosol generation device.

Preferably, the fitting algorithm comprises a recursive least squares fitting algorithm.

In this way, the energy use per aerosolisation session as a function of number of aerosolisation sessions performed data can be efficiently fitted for the determination of the number of aerosolisation sessions that can be powered.

Preferably, the fitting algorithm comprises a smoothing function configured to apply a higher weighting to energy use values determined in room temperature conditions than energy values determined in non-room temperature conditions.

In this way, the smoothing function helps to avoid changes or ‘jumps’ in the determination of the number of sessions that can be performed that may be unintuitive to the operator, such as aggressive adaptions of the forecast number of sessions that can be powered due to changing conditions.

Preferably, the controller is configured to determine an energy offset value between the fitted relationship of energy use per session as a function of number of aerosolisation sessions performed including the updated energy use value of the nth aerosolisation session, and fitted data representative of expected energy use per session as a function of number of aerosolisation sessions before any aerosolisation sessions have been performed; and
controlling the aerosol generation device to output a notification when the energy offset value exceeds a predetermined energy offset value, wherein the notification comprises an instruction to clean a heating chamber of the aerosol generation device.

In this way, the process provides for a determination that the heating chamber of the aerosol generation device should be cleaned. This internal state information is output to the user so that the user knows to clean the heating chamber to increase the number of aerosolisation sessions that can be powered in the future.

Preferably, the controller is configured to control the aerosol generation device to output the number of aerosolisation sessions that can be powered after the nth session using a display associated with the aerosol generation device.

In this way, the determined number of aerosol sessions is presented to the operator in an efficient and user friendly manner.

Preferably, the determined number of aerosolisation sessions that can be powered after the nth session based upon the updated relationship of energy use per aerosolisation session as a function of number of aerosolisation sessions performed and an energy level of the battery is a first number of aerosolisation sessions; and
the controller is configured to:
measure an energy level of the battery after the nth aerosolisation session using the battery monitor;
determine a second number of aerosolisation sessions wherein the second number of aerosolisation sessions is determined by determining a number of aerosolisation sessions that can be powered after the nth aerosolisation session by the battery at the measured energy level of the battery using a current profile of an aerosolisation session and modelled battery parameters;
compare the first number of aerosolisation sessions with the second number of aerosolisation sessions;
wherein the step of controlling the aerosol generation device to output the number of aerosolisation sessions that can be powered after the nth session comprises:
outputting the lower of the first number of aerosolisation sessions and the second number of aerosolisation sessions when the first number of aerosolisation sessions is different to the second number of aerosolisation sessions; and
outputting either the first number of aerosolisation sessions or the second number of aerosolisation sessions when the first number of aerosolisation sessions is the same as the second number of aerosolisation sessions.

In this way, a second determination of the number of aerosolisation sessions that can be powered is performed. When the first determination and second determinations determine that different numbers of aerosolisation sessions can be powered, the lower of the two is output. Overestimating the number of aerosolisation sessions that can be powered could lead to dissatisfaction for the operator of the aerosol generation device if the operator cannot perform the number of aerosolisation sessions for which the battery was predicted of being capable of powering. Determining the number of aerosolisation sessions that can be powered by the two processes, and outputting the lower of the two predictions reduces the risk of overestimating the number of aerosolisation sessions that can be powered. Operator dissatisfaction is therefore avoided.

Preferably, the controller is further configured to update the modelled battery parameters after the nth aerosolisation session based upon the acquired aerosolisation session characteristics of the nth aerosolisation session measured using the battery monitor.

In this way, real-time changes to battery are accounted for, so that an accurate determination of the number of aerosolisation sessions that can be powered is achieved with the second determination of the number of aerosolisation sessions that can be powered.

Preferably, the aerosolisation session comprises heating an aerosol generating consumable to generate an aerosol from the aerosol generating consumable.

Preferably, the aerosol generating consumable is a tobacco rod, and the aerosolisation session comprises heating the tobacco rod without burning the tobacco rod.

In a second aspect, there is provided method of operating an aerosol generation device comprising a battery, a controller and a battery monitor, wherein the method comprises:
controlling, with the controller, a power flow from the battery to a heater of the aerosol generation device to perform an nth aerosolisation session, wherein n is an integer greater than or equal to 1;
acquiring, with the controller, aerosolisation session characteristics of the nth aerosolisation session measured using the battery monitor;
accessing, with the controller, a relationship of energy use per aerosolisation session as a function of number of aerosolisation sessions performed, and updating the relationship based upon the acquired aerosolisation session characteristics of the nth aerosolisation session, wherein the relationship is stored in storage accessible by the controller;
determining, by the controller, a number of aerosolisation sessions that can be powered after the nth aerosolisation session based upon the updated relationship of energy use per aerosolisation session as a function of number of aerosolisation sessions performed and an energy level of the battery; and
controlling, by the controller, the aerosol generation device to output the number of aerosolisation sessions that can be powered after the nth session.

Preferably, the method of the second aspect includes the preferable features of the first aspect.

In a third aspect, there is provided non-transitory computer-readable medium storing instructions executable by one or more processors of an aerosol generation device comprising a battery, a controller and a battery monitor cause the one or more processors to perform steps comprising:
controlling, with the controller, a power flow from the battery to a heater of the aerosol generation device to perform an nth aerosolisation session, wherein n is an integer greater than or equal to 1;
acquiring, with the controller, aerosolisation session characteristics of the nth aerosolisation session measured using the battery monitor;
accessing, with the controller, a relationship of energy use per aerosolisation session as a function of number of aerosolisation sessions performed, and updating the relationship based upon the acquired aerosolisation session characteristics of the nth aerosolisation session, wherein the relationship is stored in storage accessible by the controller;
determining, by the controller, a number of aerosolisation sessions that can be powered after the nth aerosolisation session based upon the updated relationship of energy use per aerosolisation session as a function of number of aerosolisation sessions performed and an energy level of the battery; and
controlling, by the controller, the aerosol generation device to output the number of aerosolisation sessions that can be powered after the nth session.

Preferably, the non-transitory computer-readable medium of the third aspect includes the preferable features of the first aspect.

In a fourth aspect, there is provided an aerosol generation device comprising a battery, a controller and a battery monitor, wherein the controller is configured to:
control a power flow from the battery to a heater of the aerosol generation device to perform an nth aerosolisation session, wherein n is an integer greater than or equal to 1;
measure an energy level of the battery after the nth aerosolisation session using the battery monitor;
determine a number of aerosolisation sessions that can be powered after nth aerosolisation session by the battery with the measured energy level of the battery using an aerosolisation session current profile and modelled parameters of the battery; and
control the aerosol generation device to output the number of aerosolisation sessions that can be powered after the nth session.

Aerosol generation devices can be configured to indicate the state-of-charge of the battery, in a similar manner to a smartphone. However, this information can be non-intuitive and confusing to the user when considering how many aerosolisation sessions can be performed. It may not be clear to the user how many aerosolisation sessions can be powered for a given state-of-charge. In traditional smoking, a smoker can look in the cigarette packet and determine the number of cigarettes available to smoke. For an aerosol generation device that indicates the state-of-charge of the battery, it is not clear to the operator as to how many aerosolisation sessions can be performed. It is therefore necessary to provide a technical solution that can be used to indicate the number of remaining aerosolisation sessions that can be powered by the battery of an aerosol generation device. The fourth aspect addresses this challenge through the provision of a process for determining the number of aerosolisation sessions that can be powered by the battery, and outputting this information. Moreover, this process uses modelled parameters of the battery so that an accurate determination of the number of aerosolisation sessions that can be powered is achieved.

Preferably, the controller is configured to acquire aerosolisation session characteristics of the nth aerosolisation session measured using the battery monitor, and update the modelled parameters of the battery based upon the acquired aerosolisation session characteristics of the nth aerosolisation session.

In this way, the modelled parameters of the battery can be updated to reflect the aerosolisation session characteristics, rather than only having a predetermined value. This can improve the determination of the number of aerosolisation sessions that can be powered.

Preferably, the battery monitor comprises a voltage measurement module configured to measure a voltage of the battery for an aerosolisation session, and the acquired aerosolisation session characteristics of the nth aerosolisation session comprise a battery voltage of the nth aerosolisation session measured by the voltage measurement module.

In this way, the battery voltage can be used to determine the number of aerosolisation sessions that can be powered after the nth aerosolisation session.

Preferably, the battery monitor comprises a current measurement module configured to measure a current output by the battery in an aerosolisation session, and the acquired aerosolisation session characteristics of the nth aerosolisation session comprise a current output by the battery in the nth aerosolisation session measured by the current measurement module.

In this way, the current output of the battery can be used to determine the number of aerosolisation sessions that can be powered after the nth aerosolisation session.

Preferably, the battery monitor comprises an ambient temperature measurement module configured to measure an ambient temperature proximal to the aerosol generation device during an aerosolisation session, and the aerosolisation session characteristics of the nth aerosolisation session comprise an ambient temperature measured in the nth aerosolisation session by the ambient temperature measurement module.

In this way, the temperature proximal to the aerosol generation device can be used to in the determination of the number of aerosolisation sessions that can be powered after the nth aerosolisation session. Extreme high and low temperatures can affect the battery performance, and so factoring the temperature into the calculation improves the accuracy of the determination of the number of aerosolisation sessions that can be powered after the nth aerosolisation session.

Preferably, the nth aerosolisation session is a most recently completed aerosolisation session.

In this way, the determination of number of aerosolisation sessions that can be powered can be updated in response to the most recently completed aerosolisation session. This ensures that the operator is continually presented with the most useful information regarding the battery level of the device.

Preferably, the controller is configured to control the aerosol generation device to output the number of aerosolisation sessions that can be powered after the nth session using a display associated with the aerosol generation device.

In this way, the determined number of aerosol sessions is presented to the operator in an efficient and user-friendly manner.

Preferably, the controller is configured to determine a state-of-charge of the battery using the battery monitor, and select the aerosolisation session current profile from storage accessible by the controller wherein the selected aerosolisation session current profile corresponds to the determined state-of-charge of the battery.

In this way, the determined number of aerosolisation sessions that can be powered reflects the state-of-charge of the battery. The current output of the battery can change as the state-of-charge changes, factoring this into the determination of the number of aerosolisation sessions that can be powered therefore improves the accuracy of the determination of how many aerosolisation sessions can be powered as the charge level in the battery changes compared to using a fixed value.

Preferably, the controller is configured to monitor a current applied by the battery in the nth aerosolisation session, and update the aerosolisation session current profiles stored in the storage based upon one or more values of the monitored current and the determined state-of-charge of the battery.

In this way, the current profiles can be updated to reflect the operating conditions of the aerosol generation device, for example to account for a dirtying of the heating chamber. As such, the accuracy of the determination of how many aerosolisation sessions can be powered is improved.

Preferably, the controller is configured to determine a predicted energy usage of a future aerosolisation session based upon current values as a function of time in the aerosolisation session current profile and an impedance value of the battery based upon an impedance model of the battery using the modelled parameters of the battery.

Preferably, the controller is configured to determine a number of aerosolisation sessions that can be powered after nth aerosolisation session by the battery with the measured energy level of the battery by determining the maximum number of aerosolisation sessions that can be fully powered at the predicted energy usage of a future aerosolisation session for the measured energy level of the battery.

In this way, an efficient calculation of the number of aerosolisation sessions that can be powered is achieved.

Preferably, the aerosolisation session comprises heating an aerosol generating consumable to generate an aerosol from the aerosol generating consumable.

Preferably, the aerosol generating consumable is a tobacco rod, and the aerosolisation session comprises heating the tobacco rod without burning the tobacco rod.

In a fifth aspect, there is provided a method of operating an aerosol generation device comprising a battery, a controller and a battery monitor, wherein the method comprises:
controlling, with the controller, a power flow from the battery to a heater of the aerosol generation device to perform an nth aerosolisation session, wherein n is an integer greater than or equal to 1;
measuring, with the controller, an energy level of the battery after the nth aerosolisation session using the battery monitor;
determining, with the controller, a number of aerosolisation sessions that can be powered after nth aerosolisation session by the battery with the measured energy level of the battery using an aerosolisation session current profile and modelled parameters of the battery; and
controlling, with the controller, the aerosol generation device to output the number of aerosolisation sessions that can be powered after the nth session.

Preferably, the method of the fifth aspect includes the preferable features of the fourth aspect.

In a sixth aspect, there is provided a non-transitory computer-readable medium storing instructions executable by one or more processors of an aerosol generation device comprising a battery, a controller and a battery monitor cause the one or more processors to perform steps comprising:
controlling, with the controller, a power flow from the battery to a heater of the aerosol generation device to perform an nth aerosolisation session, wherein n is an integer greater than or equal to 1;
measuring, with the controller, an energy level of the battery after the nth aerosolisation session using the battery monitor;
determining, with the controller, a number of aerosolisation sessions that can be powered after nth aerosolisation session by the battery with the measured energy level of the battery using an aerosolisation session current profile and modelled parameters of the battery; and
controlling, with the controller, the aerosol generation device to output the number of aerosolisation sessions that can be powered after the nth session.

Preferably, the non-transitory computer-readable medium of the sixth aspect includes the preferable features of the fourth aspect.

In a seventh aspect, there is provided an aerosol generation device comprising a battery, a controller and a battery monitor, wherein the controller is configured to:
measure an energy level of the battery using the battery monitor;
calculate a number, a, of aerosolisation sessions that can be powered based upon the measured energy level of the battery and an expected energy usage per session for a first aerosolisation session heating profile, wherein a is an integer greater than or equal to 0, and a heating profile comprises one or more heating steps wherein each of the one or more heating steps corresponds to heating a heater of the aerosol generation device to a predetermined target heater temperature value for a predetermined period of time;
receive an instruction to enter an eco-mode in which a+b aerosolisation sessions can be performed, wherein b is an integer greater than or equal to 1, wherein an aerosolisation session in the eco-mode uses less energy of the battery than an aerosolisation session not in the eco-mode;
in response to the instruction to enter the eco-mode, incrementally modify the aerosolisation session heating profile and recalculate the number of aerosolisation sessions that can be powered based upon the measured energy level of the battery and an expected energy usage per session for each of the incrementally modified aerosolisation session heating profiles until a second aerosolisation session heating profile is determined at which a+b aerosolisation sessions can be performed; and
control the aerosol generation device to perform an aerosolisation session using the second aerosolisation session heating profile at which a+b aerosolisation sessions can be performed.

In this way, the heating profile of the future aerosolisation session(s) can be adjusted so that additional sessions can be performed. This improves the user experience by providing an option to perform more aerosolisation sessions when the charge level of the battery is low.

In one example, the instruction to enter the eco-mode or low power mode may be received in the form of a communication signal when a user presses a switch of the device. Alternatively, the instruction may be automatically received when the battery reaches a predetermined state-of-charge or predetermined remaining amount of energy. For example, for 7 Wh battery a 10% of remaining amount of energy would be 0.7 Wh. The unit may be received as either Wh or Joules, and it may be understood that 0.7 Wh=0.7*3600 sec=2520 Joules. The determination of a remaining amount of energy may be based on a capacity and an internal resistance of the battery. As another example, when the battery reaches a 10% state-of-charge or a 5% state-of-charge the controller may be configured to automatically switch to the eco-mode. As will be understood, different low power modes may be initiated at different states-of-charge or different remaining amounts of energy of the battery. The skilled person will understand that either (or both) of these two parameters (state-of-charge or remaining amount of energy) may be implemented in a device according to manufacturing, design or operational requirements. The instruction may be received from the battery monitor.

Preferably, incrementally modifying the aerosolisation session heating profile and recalculating the number of aerosolisation sessions that can be powered based upon the measured energy level of the battery and an expected energy usage per session for each of the incrementally modified aerosolisation session heating profiles until a second aerosolisation session heating profile is determined at which a+b aerosolisation sessions can be performed comprises, in a loop:
modifying the aerosolisation session heating profile with an incremental modification to a modified aerosolisation session heating profile;
determining an expected energy usage of an aerosolisation session with the modified aerosolisation session heating profile; and
determining the number of aerosolisation sessions that can be powered based upon the expected energy usage for an aerosolisation session with the modified aerosolisation session heating profile;
wherein the loop continues until a modified aerosolisation session heating profile is determined at which the number of aerosolisation sessions that can be powered based upon the expected energy usage for an aerosolisation session with the modified aerosolisation session heating profile is a+b; and
the controller is configured to designate the modified aerosolisation session heating profile at which a+b aerosolisation sessions can be performed as the second aerosolisation session heating profile.

In this way, by applying the incremental modifications in a loop, the aerosolisation session heating profile is only adjusted as much as is needed. This provides a balance between decreasing the energy usage in an aerosolisation session, and providing an increased number of aerosolisation sessions. The user experience is therefore improved.

Preferably, determining an expected energy usage of an aerosolisation session with the modified aerosolisation session heating profile comprises:
determining an integrated aerosolisation session heating profile value for the modified aerosolisation session heating profile by integrating the target heater temperature values as a function of time in the modified aerosolisation session heating profile; and
determining an expected energy usage of an aerosolisation session performed using the modified aerosolisation session heating profile based upon a predetermined relationship between integrated aerosolisation session heating profile values and expected energy usage in aerosolisation sessions.

In this way, the expected energy usage can be determined in an efficient manner.

Preferably, determining an expected energy usage of an aerosolisation session with the modified aerosolisation session heating profile further comprises:
normalising the determined integrated aerosolisation session heating profile value to determine a normalised integrated aerosolisation session heating profile value; and
wherein the expected energy usage of an aerosolisation session performed using the modified aerosolisation session heating profile is determined based upon a predetermined relationship between normalised integrated aerosolisation session heating profile values and expected energy usage in aerosolisation sessions.

In this way, the expected energy usage can be determined in an efficient manner.

Preferably, incrementally modifying the aerosolisation session heating profile comprises incrementally reducing a target heater temperature in the aerosolisation session heating profile, and/or incrementally adjusting a length of time of the aerosolisation session heating profile.

In this way, the energy usage per aerosolisation session is decreased so that more aerosolisation sessions can be performed. A modification may comprise increasing a pre-heating time or the length of time for pre-heating/heating up phase of the device. Further, a low power mode or a second aerosolisation session heating profile may comprise fewer heating steps than the first aerosolisation session heating profile. As an example, the eco-mode aerosolisation session heating profile may not increase the heating temperature at the end of a session. In another example, a low power aerosolisation session heating profile may have a shorter overall length of time and may turn off the heater of the device at an earlier time. In other words, an eco-mode or low power mode aerosolisation session may have a prolonged heat-up phase and a shorter vaping phase than the normal operating mode.

Preferably, the one or more heating steps is plurality of heating steps.

Preferably, each incremental modification to the aerosolisation heating profile comprises a predetermined modification to one or more of the plurality of heating steps.

In this way, only parts of the aerosolisation session heating profile need be modified, rather than the entire heating profile. This can reduce the impact on the user experience when using the eco-mode.

Preferably, each predetermined modification to one or more of the plurality of heating steps comprises a predetermined reduction in the target heater temperature of one or more of the heating steps or a predetermined adjustment to the period of time of one or more of the heating steps.

In this way, the energy usage per aerosolisation session is decreased by reducing the target heater temperature of one or more heating steps, or adjusting the period of time of one or more of the heating steps, so that more aerosolisation sessions can be performed.

Preferably, the incremental modifications have a predetermined order of preference; and
modifying the aerosolisation session heating profile comprises applying the incremental modifications in the order of preference until the second aerosolisation session heating profile is determined at which a+b aerosolisation sessions can be performed.

In this way, by performing the incremental modifications with an order of preference, modifications that have the least impact on the user experience can be applied with a higher priority. This reduces any negative impact on the overall user experience when using the eco-mode.

Preferably, the first aerosolisation session heating profile is that of a normal operating mode of the aerosol generation device.

Preferably, a normal operating mode is one in which the eco-mode is not applied.

Preferably, an aerosolisation session performed using the second aerosolisation session heating profile uses less energy of the battery than the first aerosolisation session heating profile.

Preferably, B=1 or 2.

In this way, the user can configure the aerosol generation device to power one or two additional aerosolisation sessions compared to the normal operating mode.

Preferably, the controller is configured to control the aerosol generation device to output an indication that the eco-mode has been initiated.

In this way, the user can be provided with information regarding the operating state of the aerosol generation device, so that the user knows that the eco-mode has been initiated.

Preferably, the aerosolisation session comprises heating an aerosol generating consumable to generate an aerosol from the aerosol generating consumable.

Preferably, the aerosol generating consumable is a tobacco rod, and the aerosolisation session comprises heating the tobacco rod without burning the tobacco rod.

In an eighth aspect, there is provided a method of operating an aerosol generation device comprising a battery, a controller and a battery monitor, wherein the method comprises:
measuring, with the controller, an energy level of the battery using the battery monitor;
calculating, with the controller, a number, a, of aerosolisation sessions that can be powered based upon the measured energy level of the battery and an expected energy usage per session for a first aerosolisation session heating profile, wherein a is an integer greater than or equal to 0, and a heating profile comprises one or more heating steps wherein each of the one or more heating steps corresponds to heating a heater of the aerosol generation device to a predetermined target heater temperature value for a predetermined period of time;
receiving, at the controller, an instruction to enter an eco-mode in which a+b aerosolisation sessions can be performed, wherein b is an integer greater than or equal to 1, wherein an aerosolisation session in the eco-mode uses less energy of the battery than an aerosolisation session not in the eco-mode;
in response to the instruction to enter the eco-mode, incrementally modifying, with the controller, the aerosolisation session heating profile and recalculating the number of aerosolisation sessions that can be powered based upon the measured energy level of the battery and an expected energy usage per session for each of the incrementally modified aerosolisation session heating profiles until a second aerosolisation session heating profile is determined at which a+b aerosolisation sessions can be performed; and
controlling, with the controller, the aerosol generation device to perform an aerosolisation session using the second aerosolisation session heating profile at which a+b aerosolisation sessions can be performed.

Preferably, the method of the eighth aspect includes the preferable features of the seventh aspect.

In a ninth aspect, there is provided a non-transitory computer-readable medium storing instructions executable by one or more processors of an aerosol generation device comprising a battery, a controller and a battery monitor cause the one or more processors to perform steps comprising:
measuring, with the controller, an energy level of the battery using the battery monitor;
calculating, with the controller, a number, a, of aerosolisation sessions that can be powered based upon the measured energy level of the battery and an expected energy usage per session for a first aerosolisation session heating profile, wherein a is an integer greater than or equal to 0, and a heating profile comprises one or more heating steps wherein each of the one or more heating steps corresponds to heating a heater of the aerosol generation device to a predetermined target heater temperature value for a predetermined period of time;
receiving, at the controller, an instruction to enter an eco-mode in which a+b aerosolisation sessions can be performed, wherein b is an integer greater than or equal to 1, wherein an aerosolisation session in the eco-mode uses less energy of the battery than an aerosolisation session not in the eco-mode;
in response to the instruction to enter the eco-mode, incrementally modifying, with the controller, the aerosolisation session heating profile and recalculating the number of aerosolisation sessions that can be powered based upon the measured energy level of the battery and an expected energy usage per session for each of the incrementally modified aerosolisation session heating profiles until a second aerosolisation session heating profile is determined at which a+b aerosolisation sessions can be performed; and
controlling, with the controller, the aerosol generation device to perform an aerosolisation session using the second aerosolisation session heating profile at which a+b aerosolisation sessions can be performed.

Preferably, the non-transitory computer-readable medium of the ninth aspect includes the preferable features of the seventh aspect.

### BRIEF DESCRIPTION OF DRAWINGS

Embodiments of the invention are now described, by way of example, with reference to the drawings, in which:

FIG. 1 is a diagram of an exemplary aerosol generation device;

FIG. 2 is a flow diagram depicting the progression between a pre-heating mode and heating mode in an aerosolisation session;

FIG. 3 is an operational flow chart of steps performed in a process of determining the number of remaining aerosolisation sessions that a battery can power;

FIG. 4A is a plot of predetermined energy usage per aerosolisation session as a function of aerosolisation session number;

FIG. 4B is the plot of FIG. 4A with a fitting line applied to the plot of predetermined energy usage per aerosolisation session as a function of aerosolisation session number;

FIG. 4C is the plot of FIG. 4A with an additional plot of measured energy usage per aerosolisation session as a function of aerosolisation session number;

FIG. 4D is the plot of FIG. 4C with a fitting line applied to the plot of measured energy usage per aerosolisation session as a function of aerosolisation session number;

FIGS. 5A to 5E show exemplary symbols used to indicate the number of aerosolisation sessions that the battery can power;

FIG. 6 is an operational flow chart of steps performed in a process of determining the number of aerosolisation sessions that can be powered by the battery;

FIG. 7 is an exemplary equivalent circuit model of an impedance model for the battery used in the aerosol generating device;

FIG. 8 is a plot of an exemplary simplified current profile, with current as a function of time;

FIG. 9 is an operational flow chart of steps performed in a process of determining the number of aerosolisation sessions that can be powered combining the processes of FIG. 3 and FIG. 6;

FIG. 10 is an operational flow chart of steps performed in a process of modifying a heating profile to increase the number of aerosolisation sessions that the battery is capable of powering for an eco-mode;

FIG. 11 is a plot of an aerosolisation session heating profile;

FIG. 12 is a flow chart of a processing loop for incrementally modifying an aerosolisation session heating profile and calculating the number of aerosolisation sessions that can be powered;

FIG. 13 is a plot of energy consumption per aerosolisation session as a function of a normalised integral value of the aerosolisation session heating profile;

FIGS. 14A to 14C show exemplary indications respectively of an indication displayed when an aerosol generation device is in a normal operating mode, an indication displayed when an aerosol generation device is in a first eco-mode, and an indication displayed when an aerosol generation device is in a second eco-mode;

FIGS. 15A and 15B show exemplary heating profiles for a standard aerosolisation session and a low power aerosolisation session; and

FIG. 16 shows an exemplary control schematic of the aerosol generation device.

### DETAILED DESCRIPTION

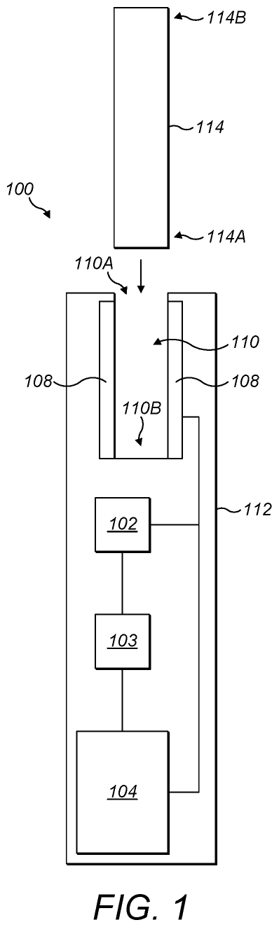

FIG. 1 shows a block diagram of the components of an aerosol generation device 100 or a vapor generation device, also known as an electronic cigarette. For the purposes of the present description, it will be understood that the terms vapor and aerosol are interchangeable.

The aerosol generation device 100 has a body portion 112 containing controller 102, and at least one battery 104. Hereinafter only one battery 104 is referred to; the skilled person will however understand that the power system can comprise one or more batteries as appropriate, and that references to “the battery” can encompass “the at least one battery”.

The aerosol generation device 100 further comprises a battery monitoring module 103, sometimes referred to as a battery fuel gauge. The battery monitoring module 103 can be controlled by the controller 102 to monitor battery characteristics such as battery voltage, current and temperature. The battery monitoring module 103 is discussed in more detail subsequently.

In an example, a heater 108 is contained within the body portion 112. In such an example, as shown in FIG. 1, the heater 108 is arranged in a heating cavity 110 or chamber in the body portion 112. The cavity 110 is accessed by an opening 110A in the body portion 112. The cavity 110 is arranged to receive an associated aerosol generating consumable 114. The aerosol generating consumable can contain an aerosol generating material, such as a tobacco rod containing tobacco. A tobacco rod can be similar to a traditional cigarette. The cavity 110 has cross-section approximately equal to that of the aerosol generating consumable 114, and a depth such that when the associated aerosol generating consumable 114 is inserted into the cavity 110, a first end portion 114A of the aerosol generating consumable 114 reaches a bottom portion 110B of the cavity 110 (that is, an end portion 110B of the cavity 110 distal from the cavity opening 110A), and a second end portion 114B of the aerosol generating consumable 114 distal to the first end portion 114A extends outwardly from the cavity 110. In this way, a consumer can inhale upon the aerosol generating consumable 114 when it is inserted into the aerosol generation device 100. In the example of FIG. 1, the heater 108 is arranged in the cavity 110 such that the aerosol generating consumable 114 engages the heater 108 when inserted into the cavity 110. In the example of FIG. 1, the heater 108 is arranged as a tube in the cavity such that when the first end portion 114A of the aerosol generating consumable is inserted into the cavity the heater 108 substantially or completely surrounds the portion of the aerosol generating consumable 114 within the cavity 110. The heater 108 can be a wire, such as a coiled wire heater, or a ceramic heater, or any other suitable type of heater. The heater 108 can comprise multiple heating elements sequentially arranged along the axial length of the cavity that can be independently activated (i.e., powered up) in a sequential order. In an alternative embodiment (not shown), the heater can be arranged as an elongate piercing member (such as in the form of needle, rod or blade) within the cavity; in such an embodiment the heater can be arranged to penetrate the aerosol generating consumable and engage the aerosol generating material when the aerosol generating consumable is inserted into the cavity. In another alternative embodiment (not shown), the heater may be in the form of an induction heater. In such an embodiment, a heating element is provided in the consumable, and the heating element is inductively coupled to the induction heater in the cavity when the consumable is inserted into the cavity. The induction heater then heats the heating element by induction.

The heater 108 is arranged to heat the aerosol generating consumable 114 to a predetermined temperature to produce an aerosol in an aerosolisation session. An aerosolisation session can be considered as when the device is operated to produce an aerosol from the aerosol generating consumable 114. In an example in which the aerosol generating consumable 114 is a tobacco rod, the aerosol generating consumable 114 comprises tobacco and the heater 108 is arranged to heat the tobacco, without burning the tobacco, to generate an aerosol. That is, the heater 108 heats the tobacco at a predetermined temperature below the combustion point of the tobacco such that a tobacco-based aerosol is generated.

The skilled person will readily understand that the aerosol generating consumable 114 does not necessarily need to comprise tobacco, and that any other suitable substance for aerosolisation (or vaporisation), particularly by heating without burning the substance, can be used in place of tobacco.

The controller 102 is configured to control the power flow of the battery 104 based upon the operating mode of the aerosolisation session. The operating modes can include a preheating mode and a heating mode.

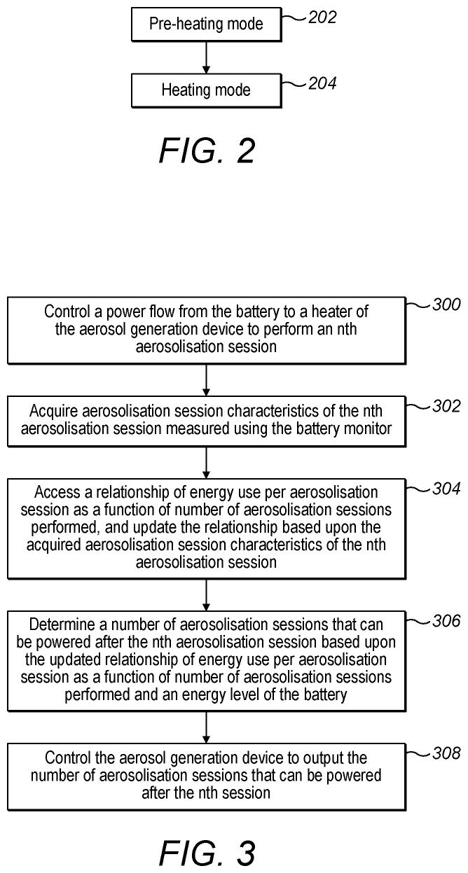

The progression from the preheating mode to the heating mode can be understood from FIG. 2. In the preheating mode 202, the heater 108 associated with the aerosol generation device 100 is heated to an aerosolisation temperature for the generation of an aerosol from the aerosol generating consumable 114. A preheating phase can be considered the time during which the preheating mode is being executed.

The preheating mode is selected by the controller 102 when an aerosolisation session is initiated by a user of the aerosol generation device 100. In an example, this preheating mode can be triggered by the controller determining that a consumer is pressing/has pressed a heating button of the device 100. In an example, an indicator such as a light emitting diode integrated into the device may be arranged to indicate that the preheating has been completed and the consumer can inhale the generated aerosol.

When the preheating phase is complete, the controller ends the preheating mode 202 and initiates the heating mode 204. In the heating mode 204 the controller 102 controls the power flow from the battery 104 to maintain the heater 108 at an aerosolisation temperature so that an aerosol is generated for the consumer to inhale. A heating phase can be considered the time during which the heating mode is being executed.

During an aerosolisation session, a heating profile is applied. The heating profile comprises one or more temperature steps to which the heater is heated with respective times for which these temperature steps are applied. When the aerosol generation device is operable with a pre-heating mode and a heating mode, the heating profile can comprise the amount of time that the heater is heated to the different temperatures in the preheating and heating phases of the aerosolisation session in that the heating steps of the heating profile can belong to the pre-heating phase or the heating phase. This could include heating the heater to the aerosolisation temperature (for example, 210 to 250 °C, or more preferably 220 to 240 °C, or more preferably 230 °C or approximately 230 °C) in the preheating phase for 10 seconds, followed by maintaining the heater at the aerosolisation temperature for 240 seconds in the heating phase; in this example the heating profile is 250 seconds in length, and comprises a 10 second temperature ramp up following by 240 seconds of constant temperature. In other examples, the heating profile can comprise different numbers of temperature steps, at different temperatures, for different periods of time.

Aerosol generation devices can be configured to indicate to the operator an estimate of the remaining charge in the battery. Indicating the state-of-charge of the battery, in a similar manner to a smartphone, can be non-intuitive and confusing to the user when considering how many aerosolisation sessions can be performed. It may not be clear to the user how many aerosolisation sessions can be powered for a given state-of-charge. In traditional smoking, a consumer can look in the cigarette packet and determine the number of cigarettes available to smoke. For an aerosol generation device that indicates the state-of-charge of the battery, it is not clear to the operator as to how many aerosolisation sessions can be performed. It is therefore necessary to provide a technical solution that can be used to indicate the number of remaining aerosolisation sessions that can be powered by the battery of an aerosol generation device.

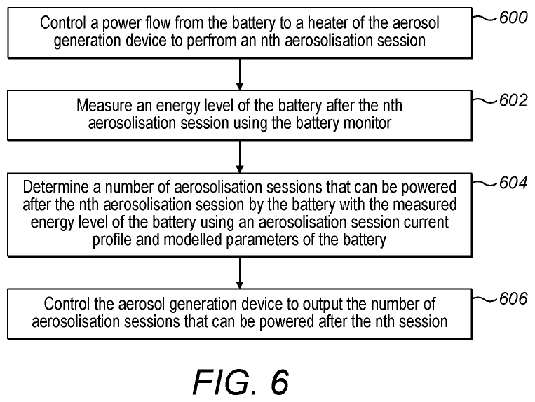

As such, FIGS. 3 and 6 present processes for determining and indicating the number of remaining aerosolisation sessions that the battery can power.

Turning first to FIG. 3, a flow chart is presented of steps performed in a process of determining the number of remaining aerosolisation sessions that the battery can power. The process of FIG. 3 can be implemented by an aerosol generation device as described with reference to FIGS. 1 and 2, or any other suitable type of aerosol generation device.

The battery can power multiple aerosolisation sessions. For example, a fully charged battery may be able to power around 25 aerosolisation sessions before it needs to be recharged. However, the amount of energy used for an aerosolisation session can change as the state-of-charge of the battery drops. That is, each aerosolisation session can use a different amount of energy. A number of other factors can also affect the amount of energy used for an aerosolisation session, such as the health of the battery, the external temperature, whether the heating chamber is dirty, and battery aging.

Through the process of FIG. 3, a relationship of energy use per session as a function of number of aerosolisation sessions performed (n) can be used in forecasting how many aerosolisation sessions the battery can power. Such a forecast relationship of energy use per session as a function of number of aerosolisation sessions performed (n) is stored in storage accessible by the controller.

This forecast relationship is a prediction of the energy usage for each aerosolisation session after the battery has been charged. That is, values can be stored that represent the expected energy usage for each aerosolisation session after the battery is fully charged, from n=1 (i.e., the first aerosolisation session after the battery is charged) to n=x (where x is the maximum number of aerosolisation sessions that can be powered by the battery when fully charged). That is, this relationship of energy use per aerosolisation session as a function of number of aerosolisation sessions performed can comprise predetermined values of energy use per aerosolisation session for a series of aerosolisation sessions performed consecutively.

The forecast relationship can be predetermined, for example during a factory calibration stage, by measuring the energy usage for each aerosolisation session in ideal circumstances (e.g., when the battery is new, fully charged and not damaged, the device is operating at room temperature, and the heating chamber is clean) from n=1 to n=x.

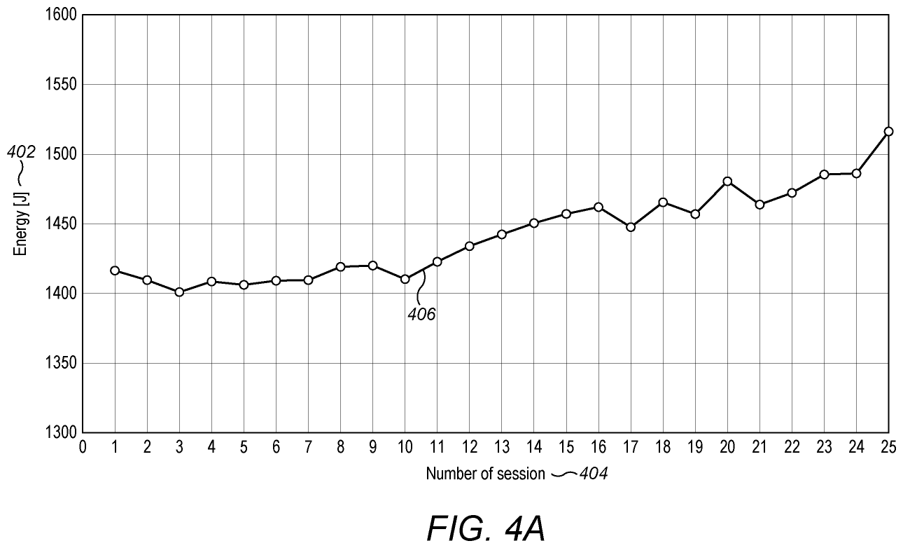

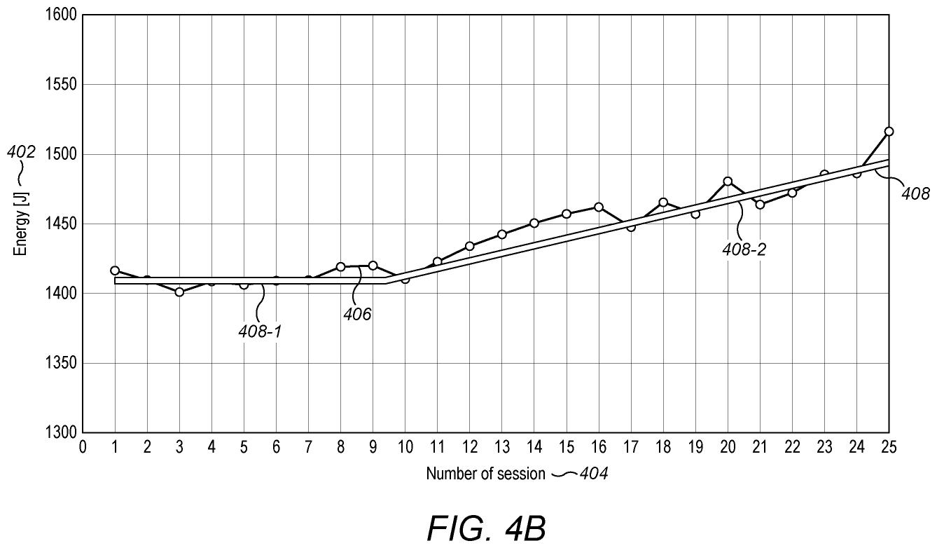

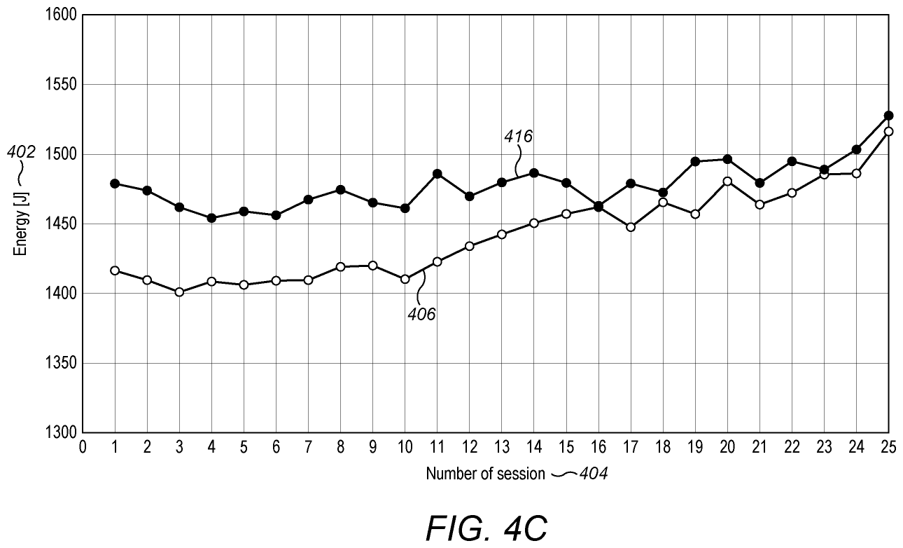

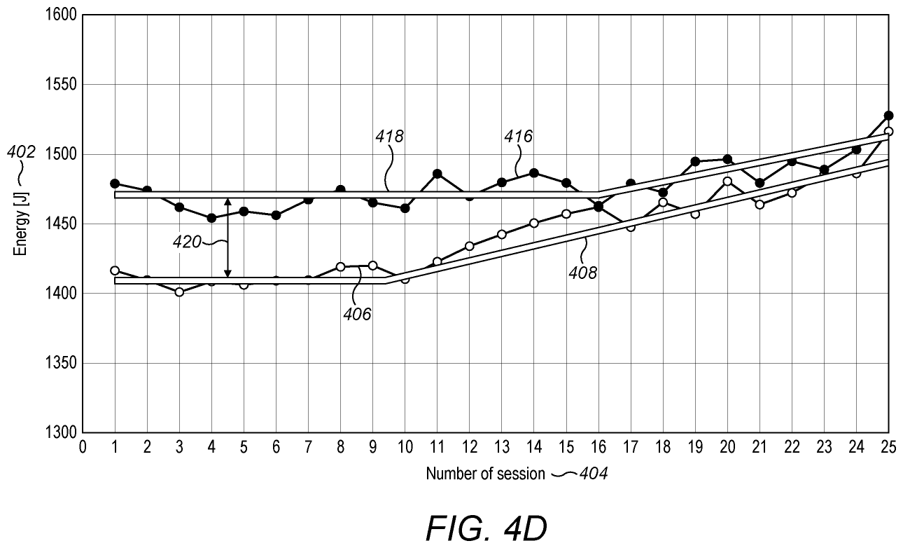

FIG. 4A shows an exemplary plot of data points 406 representing predetermined energy usage per aerosolisation session 402 as a function of aerosolisation session number 404. In this example, data is plotted for aerosolisation sessions n=1 to n=25. The number of sessions that can be powered can be determined by measuring the energy stored in the battery and then sequentially subtracting the energy values corresponding to n=1, n=2, n=3 . . . and so on until a threshold battery energy value is met. In an example, the threshold can be 0 J. The number of sessions that can be powered can then be determined as the number of subtractions that were made before the threshold was met. For example, if the subtraction of the energy value corresponding to n=23 when subtracted from the battery energy value goes below the threshold, it would be determined that 22 sessions can be powered by the battery as the energy values for n=1 to n=22 were all subtracted from the energy level of the battery before the threshold was crossed.

The data points 406 in the plot of FIG. 4A can be fitted with fitting line; FIG. 4B shows such a fitting line 408 applied to the plot of FIG. 4A.

As an alternative to using the data points for the energy values of the aerosolisation sessions n=1 to n=x, when determining the number of aerosolisation sessions that can be powered, the fitted energy values of the aerosolisation sessions n=1 to n=x can instead be used.

The data points 406 of energy usage per aerosolisation session 402 as a function of aerosolisation session number 404 can be stored in a look-up table in storage accessible by the controller. Likewise, the values of the fitting line 408 of energy usage per aerosolisation session 402 as a function of aerosolisation session number 404 can also be stored in storage accessibly by the controller. Alternatively, an equation of the fitting line can be stored in the controller and the predicted energy values of the aerosolisation sessions can be calculated using the equation of the fitting line 408.

The fitting line 408 can be split into a constant portion 408-1 and a linear slope portion 408-2. When the battery has a higher state-of-charge (i.e., a higher energy level) the energy use per session is approximately constant. This is shown by the constant portion 408-1 of the fitting line 408 corresponding to the 1st to 9th aerosolisation sessions after the battery is charged. When the battery has a lower state-of-charge (i.e., a lower energy level) the energy use per session increases. This is shown by the linear slope portion of the fitting line corresponding to the 10th to 25th aerosolisation sessions.

As discussed above, the energy usage per aerosolisation session can change over time. For example, this can be caused by non-ideal circumstances such as battery aging, high or low external temperatures, and dirtiness of the heating chamber, amongst others. To address this, the forecast relationship can be updated after each aerosolisation session by using characteristics measured for the most recently completed aerosolisation session.

At step 300, the controller controls a power flow from the battery to a heater of the aerosol generation device to perform an nth aerosolisation session, wherein n is an integer greater than or equal to 1.

In an example, the nth aerosolisation session is carried out using a first heating profile. The first heating profile can comprise the predetermined amounts of time in which the heater is heated to the different temperatures in preheating and heating phases of the aerosolisation session.

At step 302, the controller acquires aerosolisation session characteristics of the nth aerosolisation session measured using the battery monitor. The nth aerosolisation session can be considered as the most recently completed aerosolisation session.

The controller can use the battery monitor to measure aerosolisation session characteristics relating to the nth aerosolisation session, or the battery monitor can measure aerosolisation session characteristics of the nth aerosolisation session and send these to the controller.

The battery monitor can comprise one or more of a voltage measurement module, a current measurement module, and/or an ambient temperature measurement module, amongst other modules that can be used to measure battery parameters involved in the determination of energy usage and state-of-charge.

The voltage measurement module can be configured measure a voltage of the battery for an aerosolisation session, and the acquired aerosolisation session characteristics of the nth aerosolisation session can comprise a battery voltage measured of the nth aerosolisation session measured by the voltage measurement module. In some examples, the voltage measurement module can be a voltmeter or voltage measurement subcircuit.

The current measurement module can be configured to measure a current output by the battery in an aerosolisation session, and the acquired aerosolisation session characteristics of the nth aerosolisation session can comprise a current output by the battery in the nth aerosolisation session measured by the current measurement module. In some examples, the current measurement module can be an ammeter or current measurement subcircuit.

The ambient temperature measurement module can be configured to measure an ambient temperature proximal to the aerosol generation device during an aerosolisation session, and the aerosolisation session characteristics of the nth aerosolisation session can comprise an ambient temperature measured in the nth aerosolisation session by the ambient temperature measurement module. In some examples, the ambient temperature measurement module can be a thermometer or temperature sensing subcircuit. Extreme high and low temperatures can affect the battery performance, and so factoring the temperature into the calculation improves the accuracy of the determination of the number of aerosolisation sessions that can be powered after the nth aerosolisation session.

The battery monitor can use a combination of the measured battery voltage of the aerosolisation session, a measured current of the aerosolisation session, and the measured ambient temperature to determine the state-of-charge, state-of-health and internal resistance of the battery. With this information, the energy level of the battery can be determined (for example in Joules). For example, the state-of-charge, the state-of-health, and the internal resistance as a function of state-of-charge and temperature can be used to determine the energy content of the battery for given conditions. Using the measured and actual energy consumption as a function of state-of-charge or energy content, it is possible to determine how many aerosolisation sessions can be powered.

The measured battery voltage can be implemented in a number of ways for determining the state-of-charge, the state-of-health, and the internal resistance of the battery.

For example, in determining the state-of-charge, an algorithm executed by the controller can perform Ah counting (also known as Coulomb counting), which is frequently recalibrated using the open-circuit voltage. In such a case, a voltage measurement before the aerosolisation session (measured with a small current, not during the aerosolisation session) can be used with the Ah counting during the aerosolisation session to provide a state-of-charge value.

In another example, the controller can execute a ‘dynamic observer’ algorithm in which the state-of-charge is determined as a function of the measured current, voltage, and temperature. This can be understood as a look-up table which looks up the voltage during the aerosolisation session, with a given current, and temperature, to estimate the state-of-charge. In such an example, the battery voltage is measured during the aerosolisation session.

In an example, the state-of-health of the battery can be determined by the controller executing an algorithm that looks on the open-circuit voltages at two different state-of-charge values that correspond to amount of charge that has been removed after a confirmed full charge of the battery. For example, consider a 2 Ah cell is aged to 1 Ah. In such an example, the open circuit voltage may be measured as 4.15V, and after discharging 0.5 Ah the voltage is 3.7 V. After discharging this amount, a 2 Ah battery would instead have 3.9V (25 % SoC difference for 2 Ah nominal capacity). However, 3.7 V is measured so it can be determined that not 25% but 50% was discharged. Therefore, the state-of-health is recalibrated from 2Ah (if specified in Ah; it could instead be in % or in Joules) to 1 Ah. In this methodology, the voltage is measured before the aerosolisation session. Such an algorithm can be available on commercial fuel gauge chips.

In another example, the state-of-health could be based on resistance measurements by determining how much the resistance has increased for a certain temperature and state-of-charge. Such an approach can use dynamic voltage measurements to determine the internal resistance of the battery.

In an example, the internal resistance can be based on voltage measurements both before and during the aerosolisation session. In some examples, the voltage after the aerosolisation session can also be used to determine the internal resistance. This approach can be beneficial for monitoring degradation that is closely related to capacity loss, with the influence of longer time constant related effects such as diffusion. On the other hand, the ‘faster’ internal resistance measurements are beneficial for monitoring the power capability degradation of the battery.

The measured current of the aerosolisation session can be measured continuously during the aerosolisation session to extract the precise amount of energy consumed, as well as for the other battery related parameters discussed above.

The energy usage of the nth aerosolisation session can then be determined as the energy change in the battery over the nth aerosolisation session. In an example, this can be calculated as the difference between the energy level at the end of the (n−1)th aerosolisation session and the nth aerosolisation session. In another example, the energy change in the battery over the nth aerosolisation session could be calculated by determining the difference in the energy level of the battery at the start of the nth aerosolisation session (either before the nth aerosolisation session, or at the very beginning of the nth aerosolisation session) and the energy level of the battery at the end of the nth aerosolisation session.

At step 304, the controller accesses a relationship of energy use per aerosolisation session, and updates the relationship based upon the acquired aerosolisation session characteristics of the nth aerosolisation session.

The controller can be configured to update the relationship of energy use per session as a function of number of aerosolisation sessions performed by applying a fitting algorithm to the relationship of energy use per session as a function of number of aerosolisation sessions performed to update the relationship of energy use per session as function of number of aerosolisation sessions performed for the future aerosolisation sessions after nth session.

That is, the energy usage value of the data point corresponding to the nth aerosolisation session is updated from the previous value (e.g., the predetermined energy usage value for the nth session) to the value determined using the acquired aerosolisation session characteristics of the nth aerosolisation session. The controller then refits the plot of energy usage per aerosolisation session 402 as a function of aerosolisation session number 404 with this updated energy usage value for the nth aerosolisation session. In other words, after the nth session, the data point corresponding to the nth session is replaced by the measured energy usage in the nth session, and the fitting line is recalculated to reflect this change.

For example, if the most recently completed aerosolisation session is the 5th session after the battery is recharged (i.e., n=5), the aerosolisation session characteristics of 5th aerosolisation session will be used to determine the actual energy usage in the 5th aerosolisation session, and the energy usage value for n=5 will be updated to reflect this. The fitting line is then recalculated using the updated values of the energy use per session for n=1 to n=5 (n=1 to n=4 will already have been updated following aerosolisation sessions n=1 to n=4), and the predetermined values of energy use per session for n=6 to n=x (where x is the maximum number of aerosolisation sessions that can be powered by the battery when fully charged.

As discussed, with regard to FIG. 4B, the fitting line can have a constant portion 408-1 when the battery has a higher state of charge and a linearly increasing portion 408-2 when the battery has a lower state of charge due to the increasing energy usage per session as the state of charge of the battery drops. In some examples, when the state of charge of the battery is above a preset threshold (for example, 70%), the controller can be set to fit only the constant portion of the data points (i.e., only the data points for the sessions that take place before the state of charge drops below the preset threshold). This can improve computational efficiency.

FIG. 4C shows a modified version of the exemplary plot of data points 406 representing predetermined energy usage per aerosolisation session 402 as a function of aerosolisation session number 404 shown in FIG. 4A. In FIG. 4C the plot is modified to include a second set of data points 416. The second set of data points 416 represent measured energy usage per aerosolisation session 402 as a function of aerosolisation session number 404 for all 25 sessions. That is, each of the data points have been updated from the predetermined values (i.e., data points 406) to reflect the measured energy usage per session for each of n=1 to n=25. The measured energy usage per session for each of n=1 to n=25 for the data points 416 reflects the ‘real word’ energy usage measured in the aerosolisation sessions performed by the operator.

As can be seen from FIG. 4D, the energy usage in a ‘real word’ circumstance is higher than the predetermined energy usage in ideal circumstances. This could be due to a number of factors such as battery aging, the dirtiness of the heating chamber increasing the heating resistance, or extreme external temperatures that stress the battery, amongst others.

FIG. 4D shows a modified version of FIG. 4B. FIG. 4D includes the exemplary plot of data points 406 representing predetermined energy usage per aerosolisation session 402 as a function of aerosolisation session number 404, and the fitting line 408 for the data points 406. FIG. 4D also includes the exemplary plot of data points 416 representing measured energy usage per aerosolisation session 402 as a function of aerosolisation session number 404 for all 25 sessions in ‘real world’ circumstances, and a fitting line 418 for these updated data point 416.

In examples, the fitting process can be based on a recursive least squares approach. In particular, the fitting process can be based the recursive online trend fitting approach (although other online approaches could be used as well), based on a recursive least squares filter with a forgetting factor.

In examples, the fitting process can involve the application of a smoothing function. The smoothing function can give a higher weighting to conditions in which the battery of aerosol generation device behaves in a more linear way, for example at room temperature instead of at a very low temperature where the battery can behave in a more unexpected manner. The application of the smoothing factor can therefore be based upon the measured temperature proximal to the aerosol generation device using the temperature measurement module. This helps to avoid changes or ‘jumps’ in the determination of the number of sessions that can be performed that may be unintuitive to the operator, such as aggressive adaptions of the forecast number of sessions that can be powered due to changing conditions.

In FIGS. 4A to 4D, the data plotting and fitting is carried out as energy usage per session as a function of the number of the session. In some examples, this can be further refined such that the data plotting and fitting is carried out as energy usage per session as a function of the number of the session and the measured temperature. In other examples, the data plotting can be based upon battery state-of-charge rather than aerosolisation session number.

At step 306, the controller determines a number of aerosolisation sessions that can be powered after the nth session based upon the updated relationship and the energy level of the battery.

The energy level of the battery can be determined by the controller at the end of the nth aerosolisation session, using the battery monitor.

The controller can be configured to determine the number of aerosolisation sessions that can be powered after the nth session by calculating a number of future sessions after nth session that can be powered based upon the updated relationship of energy use per session as function of number of aerosolisation sessions performed for future aerosolisation sessions after nth session and the energy level of the battery.

That is, the fitting line that has been updated or recalculated with the data point corresponding to the nth session replaced by the measured energy usage in the nth session can then used to determine number of aerosolisation sessions that can be powered after the nth session. The number of sessions that can be powered can be determined using the measured energy stored in the battery and then sequentially subtracting the energy values of the updated fitting line corresponding to aerosolisation sessions n+1, n+2, n+3 and so on until the threshold battery energy value is met.

In the above example in which the most recently completed aerosolisation session is the 5th session after the battery is recharged (i.e., n=5), the subtractions of the energy value per session from the measured battery energy level start with the expected energy usage value for n=6 (i.e., n +1 where n=5) of the fitting line, and continue with subtracting the energy use per session values for n=7, n=8 . . . and so on of the fitting line until the threshold energy level is crossed. If the subtraction of the energy value corresponding to n=20 when subtracted from the battery energy value goes below the threshold, it would be determined that the aerosol generation device can power 14 more aerosolisation session (i.e., the 6th to 19th aerosolisation sessions) as the energy values for n=6 to n=19 were all subtracted from the energy level of the battery before the threshold was crossed.

This process is repeated after each finished aerosolisation session after the nth session, by updating the energy usage of the (n+1)th session, and refitting the energy use per session as a function of session number, then updating the energy usage of the (n+2)th session, and refitting the energy use per session as a function of session number, then updating the energy usage of the (n+3)th session, and refitting the energy use per session as a function of session number, and so on.

In this way, the controller can continually update the fitting of the energy usage per session, and revise the forecast number of aerosolisation sessions that can be performed in view of how the aerosol generation device is operating for example due to battery aging, high or low external temperatures, and dirtiness of the heating chamber, amongst others.

At step 308, the controller controls the aerosol generation device to output the number of aerosolisation sessions that can be powered after the nth session.

In some examples, the aerosol generation device can include a display screen and the outputting the number of aerosolisation sessions that can be powered after the nth session can be displayed on such a screen. In other examples, the aerosol generation device can include one or more indicating lights (such as LEDs) and the outputting the number of aerosolisation sessions that can be powered after the nth session can be displayed by illuminating such indicating lights in different manners (e.g., the number of lights illuminated, the colour of illumination, a flashing pattern etc.). In other examples, the aerosol generation device can comprise an audio output device, such as a speaker, and the outputting the number of aerosolisation sessions that can be powered after the nth session can be audibly output from the speaker. In other examples, the aerosol generation device could be paired to an external device such as a smartphone, for example by a wireless connection such as Bluetooth, or a wired connection through a physical interface; in such examples the outputting the number of aerosolisation sessions that can be powered after the nth session can involve transmitting data corresponding to the number of session that can be performed to the external device, and the external device can then be used to indicate the number of sessions that can be performed.

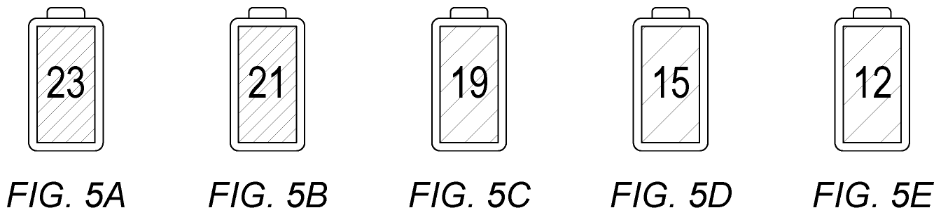

FIGS. 5A to 5E show exemplary symbols which may be used on a display of or associated with the aerosol generation device to indicate the number of aerosolisation sessions that the battery can power.

FIG. 5A shows an exemplary symbol for a determination that the battery can power 23 aerosolisation sessions. In some examples, this might be associated with a new battery (i.e., a battery for which aging has not affected its capacity) that is substantially fully charged, and when fully charged can power the maximum number of aerosolisation sessions; in such a case x=23.

FIG. 5B shows an exemplary symbol for a determination that the battery can power 21 aerosolisation sessions. In some examples, this might be associated with a battery that is in good health, but has been used for two aerosolisation sessions (in the example where x=23) and so is no longer fully charged. In other examples, this might be associated with a battery that is substantially fully charged but with a heating chamber that needs to be cleaned; that is, the dirtiness of the heating chamber is reducing the number of aerosolisation sessions that can be powered.

The different symbols of FIGS. 5A to 5E may be displayed in different colours. These colours can be associated with the health of the battery and the operating conditions of the aerosol generation device.

For example, when the battery is new (i.e., not aged) and fully charged, or new and partially discharged, or new and fully charged but the heating chamber of the aerosol generation device needs to be cleaned, the symbol may be presented in a first colour (e.g., green). This can correspond to FIG. 5A for a new battery, and FIG. 5B for a battery that is new and partially discharged, or a battery that is new and fully charged but the heating chamber of the aerosol generation device needs to be cleaned

When battery is partially discharged and the heating chamber of the aerosol generation device needs to be cleaned, or when the battery is aged, the symbol may be presented in a different second colour (e.g., amber). This can correspond to FIG. 5C where n=19.

When the battery is very aged, or very aged and the heating chamber of the aerosol generation device needs to be cleaned, the symbol may be presented in a third colour (e.g., red). In some examples, this third colour could also be used to indicate to the operator that the battery should be replaced with a new battery.

This can correspond to FIG. 5D for a very aged battery where n=15 and FIG. 5E for a very aged battery in combination with a heating chamber of the aerosol generation device that needs to be cleaned where n=12.

Through steps 302 to 308, the controller can update the determination of the number of sessions that can be powered by the battery after each aerosolisation session, and output this to the operator. After each aerosolisation session, the controller updates the energy usage per session data for the session number that has just been completed and refits the data to forecast how many aerosolisation sessions can be powered, using the data from each aerosolisation session as it occurs. The operator is therefore provided with a dynamic determination of the number of aerosolisation sessions that can be powered, taking into account factors such as battery aging, high or low external temperatures, and dirtiness of the heating chamber, amongst others.

Returning to FIG. 4D, it can be seen that there is an offset 420 between the constant portion 408-1 of the fitting line 408 of data points 406 representing the predetermined energy usage per aerosolisation session 402 as a function of aerosolisation session number 404 and the constant portion of the fitting line 418 of the data points 416 representing the measured energy usage per aerosolisation session 402 as a function of aerosolisation session number 404. As the number of executed sessions increases from n=1 to n=x, and the fitting line is continuously updated as the energy usage values for n=1 to n=x are updated to the measured energy usage values for the respective aerosolisation session, the controller can monitor the offset 420.

This offset 420 can be due to the dirtiness of the heating chamber. When the heating chamber gets dirtier, more power is required to heat the aerosol generating consumable. Consequently, more energy is used per session. The controller can be configured to monitor the offset 420 between the fitting line 408 of the predetermined energy usage per aerosolisation session 406 and the fitting line 418 of the measured energy usage per aerosolisation session 416, each time the fitting line is updated (i.e., after each aerosolisation session). When the offset 420 exceeds a predetermined offset threshold, the controller can control the aerosol generation device to output an indication that the heating chamber needs to be cleaned.

In some examples, if the aerosol generation device includes a display screen the heating chamber cleaning notification can be presented on the display screen. If the aerosol generation device includes one or more indicating lights (such as LEDs), the heating chamber cleaning notification can be output using the indicating lights. If the aerosol generation device comprises an audio output device, such as a speaker, the heating chamber cleaning notification can be audibly output from the speaker. If the aerosol generation device can be paired to an external device such as a smartphone, for example by a wireless connection such as Bluetooth, or a wired connection through a physical interface, the heating chamber cleaning notification can be transmitted as data to the external device, and the external device can then be used to indicate to the operator that the heating chamber needs to be cleaned.

When battery is recharged from an external source (i.e., when the battery enters a new charge cycle), for subsequent aerosolisation sessions after the recharge (that is, aerosolisation sessions in the new charge cycle), the controller updates the energy usage values from the energy usage values of the previous charge cycle starting from the first aerosolisation session (n=1). That is, the controller can update the energy usage values for n=1 to n=x, respectively for each subsequent aerosolisation session from n=1 to n=x, from the values measured in the previous charge cycle to the respective values measured for aerosolisation sessions n=1 to n=x in the new charge cycle. In this way, the monitored energy usage values and the determined number of sessions that can be powered continues to reflect changes to the system (e.g., battery aging and heating chamber dirtiness) across subsequent charge cycles of the battery.

In some examples, when a new battery is installed, the energy usage values for aerosolisation sessions n=1 to n=x can be reset to the predetermined values by the controller. In this way, previous measurements of the old battery do not affect the determination of the number of sessions that can be powered by the new battery.

In some examples, the algorithm executed by the controller has the capability to adapt the already determined values for a new battery rather than being ‘reset’. Such an adaption may be slower than the simpler reset, but can continue to account for the dirtiness for the heating chamber for example. Also, if the new battery is not recognised (i.e., it is not a battery that is known to the device), the controller can use predetermined values and adapt this according to determined performance of the battery.

FIG. 6 presents a second process for determining the number of aerosolisation sessions that can be powered by the battery. The process of FIG. 6 can be implemented by an aerosol generation device as described with reference to FIGS. 1 and 2, or any other suitable type of aerosol generation device.

At step 600, the controller controls a power flow from the battery to a heater of the aerosol generation device to perform an nth aerosolisation session; n is an integer greater than or equal to 1.

In an example, the nth aerosolisation session is carried out using a first heating profile. The first heating profile can comprise the predetermined amounts of time in which the heater is heated to the different temperatures in preheating and heating phases of the aerosolisation session.

At step 602, the controller measures an energy level of the battery after the nth aerosolisation session using the battery monitor.

In a similar manner to that described with reference to FIG. 3 (step 302), the controller can acquire aerosolisation session characteristics of the nth aerosolisation session measured using the battery monitor. The nth aerosolisation session can be considered as the most recently completed aerosolisation session. The controller can use the battery monitor to measure aerosolisation session characteristics relating to an nth aerosolisation session, or the battery monitor can measure aerosolisation session characteristics of an nth aerosolisation session and send these to the controller.

As discussed with reference to FIG. 3, the battery monitor can comprise one or more of a voltage measurement module, a current measurement module, and/or an ambient temperature measurement module, amongst other modules that can be used to measure battery parameters involved in the determination of energy usage and state-of-charge. The specific details of the voltage measurement module, current measurement module and ambient temperature measurement module are not repeated here, for brevity.

The battery monitor can use a combination of the measured battery voltage of the aerosolisation session, a measured current of the aerosolisation session, and the measured ambient temperature to determine the state-of-charge, state-of-health and internal resistance of the battery. With this information, the energy level of the battery can be determined (for example in Joules), as has already been described in this document.

At step 604, the controller determines a number of aerosolisation sessions that can be powered after nth aerosolisation session by the battery with the measured energy level of the battery using an aerosolisation session current profile and modelled parameters of the battery.

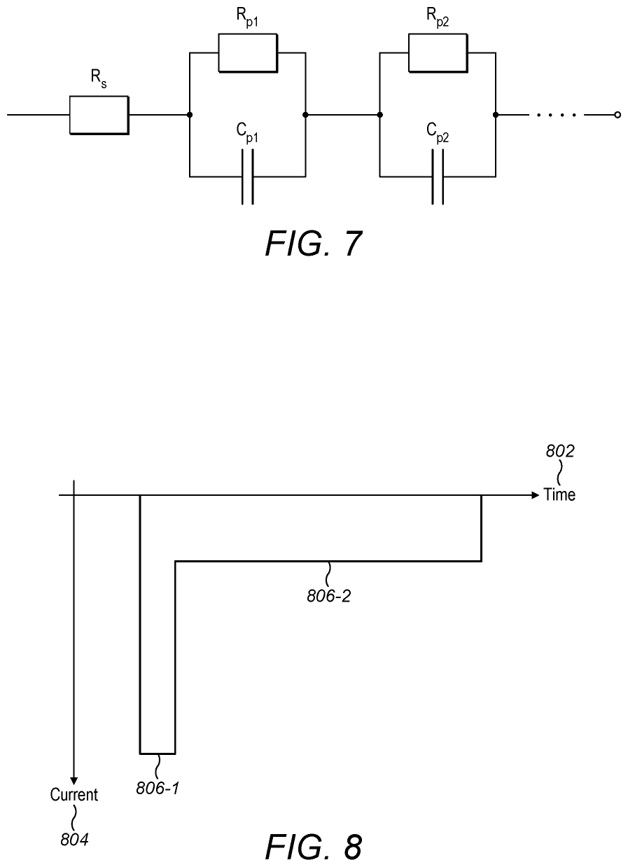

FIG. 7 shows an exemplary equivalent circuit model of an impedance model for the battery used in the aerosol generating device. The modelled battery parameters can be the resistor values (e.g., Rₛ, Rₚ₁, Rₚ₂ in the example of FIG. 7) and the capacitor values (e.g., Cₚ₁, Cₚ₂ in the example of FIG. 7) of the components in the equivalent circuit model.

In some examples, the controller can update the modelled battery parameters after the nth aerosolisation session based upon the acquired aerosolisation session characteristics of the nth aerosolisation session measured using the battery monitor. For example, the modelled battery parameters can be updated based upon an internal resistance of the battery measured using the battery monitor. The modelled battery parameters can also be updated using self-adaptive characteristic maps. The adaption of the model can be based on the measured voltage response of the battery such that the model is adapted in a way that the modelled voltage response for given current and temperature input is the same as the measured voltage response for the current and temperature input.

The aerosolisation session current profile can be a simplified current profile. A current profile can be data representing applied current from the battery as a function of time for an aerosolisation session. A ‘real’ current profile (i.e., a current profile measured in an aerosolisation session) can be highly dynamic in that the current fluctuates with time. The simplified current profile can use one or more current values as a function of time as a simplified representation of a ‘real’ current profile. FIG. 8 shows a plot of an exemplary simplified current profile, with current 804 as a function of time 802. In this example, the simplified current profile uses two constant current values 806-1 and 806-2. In other examples, the simplified current profile may use any suitable number of current values, for example, one, five or ten. The skilled person will readily understand that, for a simplified current profile, any number of constant current values can be used, provided that a simplification is applied in that there are fewer current values than for a ‘real’ current profile in which the current value frequently and dynamically changes.

The current profile will increase with battery ageing. The voltage drop will increase (increasing internal resistance), so to deliver the same power/energy, higher currents are needed. As such, the simplified current profile can be adapted as the battery ages.

In an implementation, the one simplified current profile may be stored in storage accessible by the controller. The controller can access this simplified current profile and use it to determine how many aerosolisation sessions can be performed based upon the determined energy level of the battery.

As the state-of-charge of the battery drops, the current profile applied by the battery for an aerosolisation session can change. As such, in a more advanced implementation, multiple simplified current profiles can be stored in storage accessible by the controller. These simplified current profiles can be stored in a look-up table as a function of state-of-charge of the battery. That is, simplified current profiles as a function of battery state-of-charge can be stored in storage accessible by the controller. The controller can determine the state-of-charge of the battery using the aerosolisation session characteristics and then select a simplified current profile that corresponds to the determined state-of-charge.

In some examples, the current profile can be derived from the amount of energy needed for an aerosolisation session. The energy amount can be equal to the current profile multiplied by the estimated or expected voltage response.

The predicted energy usage of a future aerosolisation session can be determined based upon current values as a function of time in the simplified current profile, and an impedance value of the impedance model of the battery based upon the modelled battery parameters.

In an example, the predicted energy usage of the future aerosolisation session can be calculated by multiplying the current profile by the expected battery voltage response when this current profile is applied to the impedance model of the battery.

In another example, the predicted energy usage of the future aerosolisation session can be calculated as the product of the square of the current values as a function of time from the simplified current profile and the impedance value of the impedance model of the battery based upon the modelled battery parameters. That is:

E_{Session}=ΣI(t)²Rt

wherein E_{Session} is the energy used in a single aerosolisation session and R is the impedance based upon the modelled parameters of the battery. I(t) is the current value applied for a given amount of time in the simplified current profile, and t is the time for which said current is applied. The energy used in the aerosolisation session can therefore calculated as the sum of the square of the current value as a function of time multiplied by the impedance and time for which the current value is applied for all current values applied in the simplified current profile.

The controller can determine the number of aerosolisation sessions that can be powered after nth aerosolisation session by the battery with the measured energy level of the battery by determining the maximum number of aerosolisation sessions that can be fully powered at the predicted energy usage of the future aerosolisation session for the measured energy level of the battery.

This can be achieved by dividing the measured energy level of the battery by the predicted energy usage of the future aerosolisation session. The result of this division can then be rounded down to nearest whole number to correspond to the number of future aerosolisation sessions that can be fully powered (i.e., disregarding any sessions that can only be partially powered).

Whilst the foregoing describes using simplified current profiles, the method could also be carried out using ‘real’ current profiles, i.e., the current profile of the nth aerosolisation session.

At step 606, the controller controls the aerosol generation device to output the number of aerosolisation sessions that can be powered after the nth session.

Outputting the number of aerosolisation sessions that can be powered after the nth session can be carried out in the manners described with reference to step 308 of FIG. 3, and as such these are not repeated here for brevity.

In a further refinement to the determination of the number of aerosolisation sessions that can be powered after the nth session, the controller can be configured to execute both the process of FIG. 3 and the process of FIG. 6n combination.

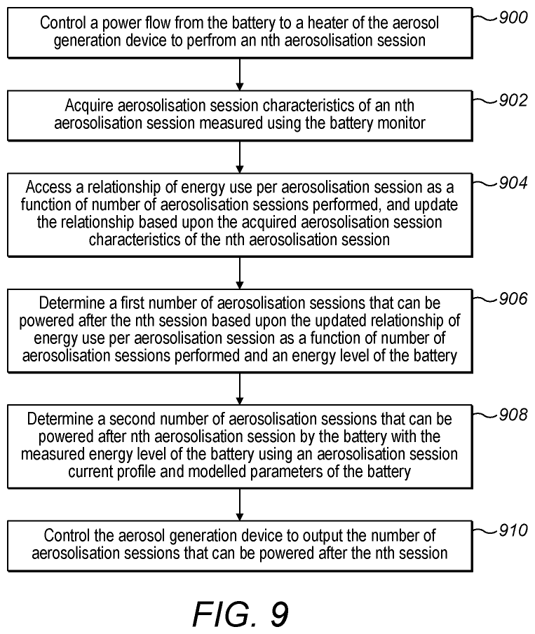

This is described in more detail with reference to FIG. 9, as follows.

At step 900, the controller can control a power flow from the battery to a heater of the aerosol generation device to perform an nth aerosolisation session. This corresponds to steps 300 and 600 in the process of FIG. 3 and FIG. 9 respectively.

At step 902, the controller can acquire aerosolisation session characteristics measured of the nth aerosolization session measured using the battery monitor. This corresponds to step 302 of the process of FIG. 3, and the measuring of the energy level of the battery after the nth aerosolisation session using the battery monitor at step 602 of FIG. 6.

At step 904, the controller can access a relationship of energy use per aerosolisation session as a function of number of aerosolisation sessions performed, and update the relationship based upon the acquired aerosolisation session characteristics of the nth aerosolisation session. This corresponds to step 304 of the process of FIG. 3.

At step 906, the controller can determine a first number of aerosolisation sessions that can be powered after nth session based upon the updated relationship of energy use per aerosolisation session as a function of number of aerosolisation sessions performed and an energy level of battery. This corresponds to step 306 of FIG. 3, and the first number of aerosolisation sessions can correspond to the number of aerosolisation sessions determined at step 306 of FIG. 3.

At step 908, the controller can determine a second number of aerosolisation sessions that can be powered after nth aerosolisation session by the battery with the measured energy level of the battery using an aerosolisation session current profile and modelled parameters of the battery. This corresponds to step 604 of FIG. 6, and the second number of aerosolisation sessions can correspond to the number of aerosolisation sessions determined at step 604 of FIG. 6.

At step 910, the controller can control the aerosol generation device to output the number of aerosolisation sessions that can be powered after the nth session.

When the first number of aerosolisation sessions is different to the second number of aerosolisation sessions, the step of controlling the aerosol generation device to output the number of aerosolisation sessions that can be powered after the nth session at step 910 comprises outputting the lower of the first number of aerosolisation sessions and the second number of aerosolisation sessions.

When the first number of aerosolisation sessions is the same as the second number of aerosolisation sessions the step of controlling the aerosol generation device to output the number of aerosolisation sessions that can be powered after the nth session at step 910 comprises outputting either the first number of aerosolisation sessions or the second number of aerosolisation sessions (because it is the same number).

That is, the controller determines whether the number of aerosolisation sessions that can be powered after the nth session as determined by the process of FIG. 3 is different to the number of aerosolisation sessions that can be powered after the nth session as determined by the process of FIG. 6. When there is a difference, the controller controls the aerosol generation device to output the lower of the two determined numbers of aerosolisation sessions that can be powered. When there is not a difference, the controller can be configured to control the aerosol generation device to output either of the two determined numbers of aerosolisation sessions that can be powered because they are the same.

In this way, when the two processes determine that different numbers of aerosolisation sessions that can be powered, the lower of the two is output. Overestimating the number of aerosolisation sessions that can be powered could lead to dissatisfaction for the operator of the aerosol generation device if the operator cannot perform the number of aerosolisation sessions for which the battery was predicted of being capable of powering. Determining the number of aerosolisation sessions that can be powered by the two processes (described with reference to FIGS. 3 and 6) in combination (as in FIG. 9), and outputting the lower of the two predictions reduces the risk of overestimating the number of aerosolisation sessions that can be powered. Operator dissatisfaction is therefore avoided.

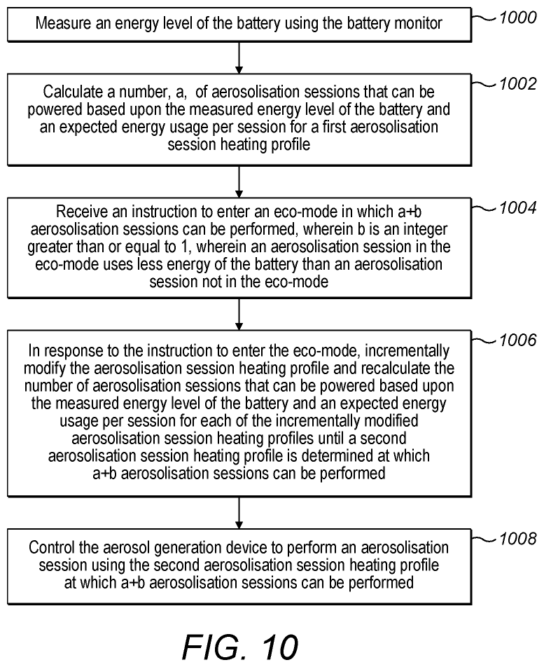

In some cases, the operator may wish to perform more aerosolisation sessions than the battery is determined as being capable of powering. For example, a full battery charge may be capable of heating a set number of aerosol sticks, e.g. 15 sticks or 20 sticks, but as a battery ages or reaches a low state-of-charge (e.g. 5-10% of remaining battery charge), it may be desirable to perform additional aerosolization sessions using limited energy or power usage. To address this issue, the controller can adapt or modify the heating profile used in an aerosolisation session to increase the number of aerosolisation sessions that the battery is capable of powering. Accordingly, this technique can advantageously reduce the required energy content in the battery of a device whilst still being able to provide an expected number of aerosolization sessions for the user. This process is presented in FIG. 10.

The process of FIG. 10 can be used in combination with one of the processes of FIG. 3, 6 or 9 in which the number of aerosolisation sessions that can be powered is determined, or in combination with any other process in which the number of aerosolisation sessions that can be powered is determined. The process of FIG. 10 can be implemented by an aerosol generation device as described with reference to FIGS. 1 and 2, or any other suitable type of aerosol generation device.

At step 1000, the controller measures an energy level of the battery using the battery monitor.

At step 1002, the controller calculates a number, a, of aerosolisation sessions that can be powered based upon the measured energy level of the battery and an expected energy usage per session for a first aerosolisation session heating profile. The value of a is an integer greater than or equal to 0.

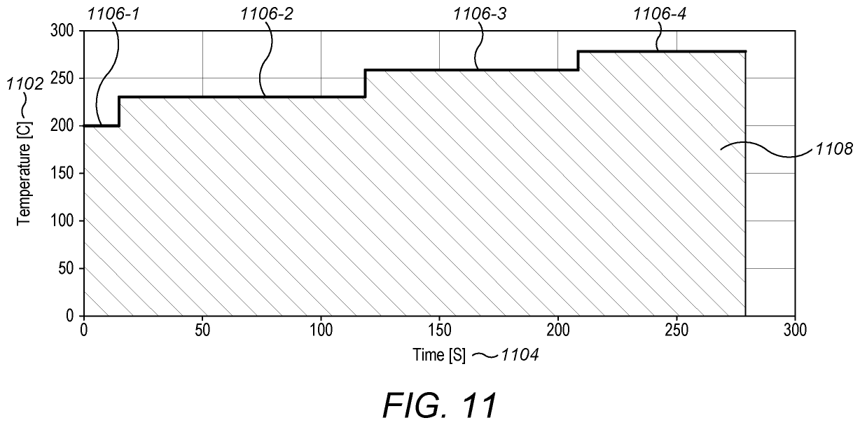

As discussed, a heating profile comprises one or more heating steps wherein each of the one or more heating steps corresponds to heating a heater of the aerosol generation device to a predetermined target heater temperature value for a predetermined period of time. FIG. 11 shows an exemplary aerosolisation session heating profile. The heating profile is presented as a plot of target heater temperature 1102 as a function of time 1104 in the aerosolisation session. In this case the aerosolisation session heating profile has four heating steps labelled 1106-1, 1106-2, 1106-3 and 1106-4. The skilled person will readily appreciate that an aerosolisation session heating profile can have any suitable number of steps greater than or equal to one. These heating steps correspond to different target temperatures to which the heater is heated for predetermined periods of time in an aerosolisation session. During the aerosolisation session, the heater is progressively heated through such target temperatures to aerosolise the aerosol generating material. In some examples, the different heating steps are set to different target temperatures. However, some steps can be set to the same target temperature. Likewise, the different heating steps can be set to take different amounts or periods of time in the aerosolisation session. However, some steps can be set to be the same amount or period of time in the aerosolisation session.

The first aerosolisation session heating profile can be that of a normal operating mode of the aerosol generation device.

The number of aerosolisation sessions a that can be powered when the first aerosolisation session heating profile is applied can be determined using the methods of FIGS. 3, 6, 9. Alternatively, any other suitable method can be used to determine the number of aerosolisation sessions that the battery is capable of powering. For example, the controller could measure battery energy level using battery monitor, and divide the measured battery energy level by a predetermined fixed expected energy usage per session that is associated with the first aerosolisation session heating profile. This value could then be rounded down to the nearest number of cycles that can be fully powered.

At step 1004, the controller receives an instruction to enter an eco-mode in which a+b aerosolisation sessions can be performed, wherein b is an integer greater than or equal to 1. An aerosolisation session in the eco-mode uses less energy of the battery than an aerosolisation session not in the eco-mode. That is to say, an aerosolisation session in the eco-mode can be considered an aerosolisation session that makes a more economical use of battery energy than an aerosolisation session in a non-eco or normal operating mode. This allows for more aerosolisation sessions to be performed than in the normal operating mode.

At step 1006, in response to the instruction to enter the eco-mode, the controller incrementally modifies the aerosolisation session heating profile and recalculates the number of aerosolisation sessions that can be powered based upon the measured energy level of the battery and an expected energy usage per session for each of the incrementally modified aerosolisation session heating profiles until a second aerosolisation session heating profile is determined at which a+b aerosolisation sessions can be performed.

An aerosolisation session performed using the second aerosolisation session heating profile uses less energy of the battery than the first aerosolisation session heating profile. That is to say, the first aerosolisation session heating profile is one used in a normal operating mode, whilst the second aerosolisation session heating profile is one used in the eco-mode (or lower power mode) that uses less energy so that more aerosolisation session can be performed for a given energy level of the battery.

In some examples, b can have a value of one (b=1). In such an example, when the eco-mode is initiated, the controller determines modifications to the aerosolisation session heating profile that are needed for the battery to be able to power one more aerosolisation session than the battery would have been able to power using the first aerosolisation session heating profile. Additionally or alternatively, b can have a value of two (b=2). In this case, when the eco-mode is initiated, the controller determines modifications to the aerosolisation session heating profile that are needed for the battery to be able to power two more aerosolisation sessions than the battery would have been able to power using the first aerosolisation session heating profile.

In some examples, the aerosol generation device can be switchable between the normal operating mode in which a aerosolisation sessions can be powered, and multiple eco-modes in which a+b aerosolisation sessions can be powered. For example, the aerosol generation device can be configured to operate in different eco-modes in which different numbers of additional aerosolisation sessions can be powered. In such an example, there could be first eco-mode in which one additional aerosolisation session can be powered (b=1), and a second eco-mode in which two additional aerosolisation sessions can be powered (b=2). In this example, the normal operating mode uses more energy in an aerosolisation session than aerosolisation sessions in both the first eco-mode and the second eco-mode. The first eco-mode uses more energy in an aerosolisation session than the second eco-mode, but less than an aerosolisation session in the normal operating mode. The second eco-mode uses less energy than both the first eco-mode and the normal operating mode for an aerosolisation session.

The skilled person will, however, understand that the same methodology could be applied to modify aerosolisation session heating profile to power more than two additional aerosolisation sessions in an eco-mode.

The aerosol generation device can have a means for switching the operating mode between the normal mode and the eco-mode(s). In an example this could be a button which when pressed triggers the eco-mode. In another example, the eco-mode(s) or low power mode(s) may be automatically initiated when the battery reaches a predetermined state-of-charge or predetermined remaining amount of energy, for example when the battery reaches a 10% state-of-charge or a 5% state-of-charge, or when the battery reaches a 10% remaining amount of energy or a 5% remaining amount of energy. The determination of a remaining amount of energy may be based on a capacity and an internal resistance of the battery. To put it in another way, the controller may be configured to automatically switch to an eco-mode(s) or low power mode(s) when the battery charge falls below a predetermined threshold. As will be understood, different low power modes may be initiated at different states-of-charge and/or different remaining amounts of energy of the battery. To determine the second aerosolisation session heating profile, the controller can incrementally modify the aerosolisation session heating profile by incrementally reducing a target heater temperature in the aerosolisation session heating profile. Alternatively or additionally, the controller can incrementally modify the aerosolisation session heating profile by incrementally reducing or adjusting a length of time of the aerosolisation session heating profile.

These incremental modifications to the aerosolisation heating profile can comprise a predetermined modification to one or more of the plurality of heating steps. The predetermined modifications to the heating steps can be stored in storage accessible by the controller.

In more detail, each predetermined modification to one or more of the plurality of heating steps can comprise a predetermined reduction in the target heater temperature of one or more of the heating steps or a predetermined adjustment to the period of time of one or more of the heating steps.

As explained with regard to FIG. 11, the aerosolisation session heating profile can have a plurality of heating steps. A modification to the aerosolisation session heating profile can comprise modifying a heating step by reducing the target temperature of the heating step, or adjusting how long the heating step is applied for.

In some examples, a modification may comprise adjusting the target temperature of a heating step or the length of time that a heating step is applied for. In other examples, a modification can comprise both adjusting the target temperature of a heating step and the length of time that the heating step is applied for. In yet further examples, a modification may comprise adjusting the target temperature of more than one heating step and/or the length of time that more than one heating step is applied for. A modification may comprise increasing a pre-heating time or the length of time for pre-heating/heating up phase of the device. Further, a low power mode or a second aerosolisation session heating profile may comprise fewer heating steps than the first aerosolisation session heating profile. As an example, the low power aerosolisation session heating profile may not increase the heating temperature at the end of a session. In another example, a low power aerosolisation session heating profile may have a shorter overall length of time and may turn off the heater of the device at an earlier time. In other words, an eco-mode or low power mode aerosolisation session may have a prolonged heat-up phase and a shorter vaping phase than the normal operating mode.

When modifying the aerosolisation session heating profile, in a first modification, the controller can modify a first heating step by reducing the target heater temperature and/or adjusting the length of time that the step is applied for. Then in a second modification after the first modification, the controller can modify a second heating step (the same or different to the first heating step) by reducing the target heater temperature and/or adjusting the length of time that the step is applied for.

The adjustment to the period of time that one or heating steps are applied for can comprise reducing the length of time that the heating step is applied for. In some examples, the controller can adjust the period time one heating step is applied for, to reduce the overall time of the aerosolisation session, thereby reducing the energy required for the aerosolisation session.

In another example of a predetermined adjustment to the period of time of one or more of the heating steps, the controller can reduce the length of time that each heating step is applied for. For example, this could be brought about by shortening each heating step by a predetermined number of seconds, or by a predetermined percentage. Again, this reduces the overall time of the aerosolisation session, thereby reducing the energy required for the aerosolisation session.

The adjustment to the period of time that one or heating steps are applied for can also comprise increasing the length of time that one or more heating steps are applied for. Increasing the length of time that heating step(s) in the preheating phase are applied for can allow for a more gradual preheating which uses lower energy than a faster (i.e., shorter in terms of time) preheating phase. This then reduces the energy required for the aerosolisation session.

The incremental modifications can have a predetermined order of preference in which they are applied. That is, modifying the aerosolisation session heating profile can comprise applying the incremental modifications in the order of preference until the second aerosolisation session heating profile is determined at which a+b aerosolisation sessions can be performed. This order of preference can be stored in storage accessible by the controller.

In an example of this prioritisation, or order for preference, for modifications to the aerosolisation session heating profile, the controller could apply the modifications in the following order, until it is determined that a+b sessions can be performed:
1. Reduce second heating step by 20 °C; then
2. Reduce third heating step by 30 °C; then
3. Reduce first heating step by 10 °C; then
4. Reduce overall session duration by 20 seconds.

This skilled person will understand that this order of preference is only an example, and in other examples the heating steps and overall session duration can be modified in different orders and by different amounts.

For each incremental modification to the aerosolisation session heating profile, the controller determines how many aerosolisation sessions can be powered based upon the measured battery energy level. In an example, this can be achieved by dividing the measured battery energy level by an expected energy usage for an aerosolisation session using the modified aerosolisation session heating profile. This value could then be rounded down to the nearest number of aerosolisation sessions that can be fully powered.

By applying the modifications incrementally, in this way, the impact on the overall aerosolisation session is minimised compared to, for example, applying a much greater reduction/adjustment to the heating profile that is of a fixed magnitude to ensure that energy use is considerably lowered. Applying the modifications incrementally allows for a fine-tuning of the modifications so that the heating profile is only adjusted as much as is necessary to be able to power a+b aerosolisation sessions. Beneficially, this gives a balance between providing a+b aerosolisation sessions and not having an unnecessarily detrimental effect on the quality of the aerosolisation sessions when achieving a+b aerosolisation sessions.

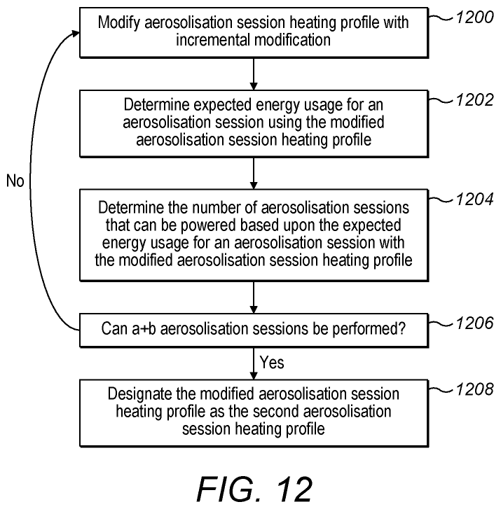

The incremental modification of the aerosolisation session heating profile and recalculation of the number of aerosolisation sessions that can be powered can comprise performing a loop. FIG. 12 shows a flowchart of such a loop.

In the loop the controller can firstly modify the aerosolisation session heating profile to a modified aerosolisation session heating profile with an incremental modification, at step 1200. The controller can then determine an expected energy usage of an aerosolisation session with the modified aerosolisation session heating profile, at step 1202. At step 1204, the controller can then determine the number of aerosolisation sessions that can be powered based upon the expected energy usage for an aerosolisation session with the modified aerosolisation session heating profile. At step 1206, the controller can determine whether the number of aerosolisation sessions that can be performed is a+b aerosolisation sessions. When a+b aerosolisation sessions can be performed, the process proceeds to step 1208, and the controller can then designate the modified aerosolisation session heating profile at which a+b aerosolisation sessions can be performed as the second aerosolisation session heating profile. When a+b sessions cannot be performed (i.e., only a sessions can be performed), the loop is repeated by returning to step 1200. The loop is repeated until a modified aerosolisation session heating profile is determined at which the number of aerosolisation sessions that can be powered based upon the expected energy usage for an aerosolisation session with the modified aerosolisation session heating profile is a+b.

Determining the expected energy usage of an aerosolisation session with the modified aerosolisation session heating profile can comprise determining an integrated aerosolisation session heating profile value for the modified aerosolisation session heating profile by integrating the target heater temperature values as a function of time in the modified aerosolisation session heating profile. Then the controller can determine the expected energy usage of an aerosolisation session performed using the modified aerosolisation session heating profile based upon a predetermined relationship between integrated aerosolisation session heating profile values and expected energy usage in aerosolisation sessions. This predetermined relationship can be stored in storage accessible by the controller.

The integrated aerosolisation session heating profile value can be calculated by the controller, and conceptually understood as the area 1108 under the heating profile temperature line, as in the plot of target heater temperature 1102 as a function of time 1104 for the heating profile in FIG. 11.

In a further refinement, determining the expected energy usage of an aerosolisation session with the modified aerosolisation session heating profile can comprise normalising the determined integrated aerosolisation session heating profile value to determine a normalised integrated aerosolisation session heating profile value. The expected energy usage of an aerosolisation session performed using the modified aerosolisation session heating profile can then be determined based upon a predetermined relationship between normalised integrated aerosolisation session heating profile values and expected energy usage in aerosolisation sessions. This predetermined relationship can be stored in storage accessible by the controller.

The integrated aerosolisation session heating profile value can be normalised against a predetermined value, for example a maximum integrated aerosolisation session heating profile value. The maximum integrated aerosolisation session heating profile value would be the integrated aerosolisation session heating profile value of an aerosolisation session heating profile that when used for an aerosolisation session uses a maximum amount of power or energy. That is, the normalised integrated aerosolisation session heating profile value would have a maximum value of 1, and this would be for a maximum power aerosolisation session heating profile.

The normalised integrated aerosolisation session heating profile value can be determined by dividing the integrated aerosolisation session heating profile value for the incrementally modified aerosolisation session heating profile by the maximum integrated aerosolisation session heating profile value.

As the aerosolisation session heating profile is incrementally modified, the normalised integrated aerosolisation session heating profile value decreases from the maximum value of 1 as the target heater temperature is reduced for the heating steps, and/or the length of time is progressively adjusted because these incremental modifications progressively decrease the expected energy usage in aerosolisation sessions using the modified heating profiles.

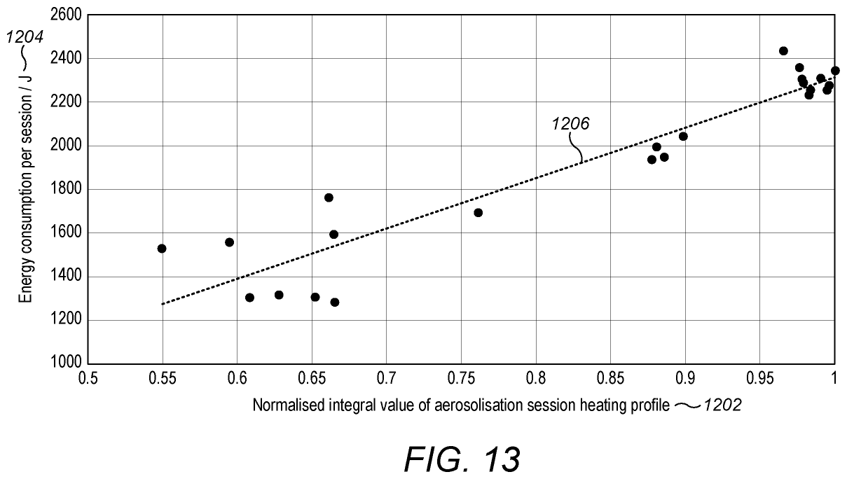

FIG. 13 shows a plot of energy consumption per aerosolisation session 1304 as a function of the normalised integral value of the aerosolisation session heating profile 1302. As can be seen from FIG. 13, there is a linear relationship 1306 between energy consumption per aerosolisation session 1304 and the normalised integral value of the aerosolisation session heating profile 1302.

This linear relationship can be used by the controller to determine the expected energy usage in an aerosolisation session for each incrementally modified aerosolisation session heating profile.

For example, a look-up table can be stored in storage accessible by the controller. In this look up table, values of expected energy usage can be stored with respective normalised integral values for the aerosolisation session heating profiles. In this way, the controller can determine the normalised integral value for the incrementally modified aerosolisation session heating profile, and then look-up the expected energy usage for an aerosolisation session using this incrementally modified aerosolisation session heating profile.

In an alternative to the look-up table approach, the controller can calculate the expected energy usage for an aerosolisation session using a predetermined relationship between the normalised integral value of aerosolisation session heating profile and the expected energy usage of an aerosolisation session using the aerosolisation session heating profile. In an example, this predetermined relationship can be the equation of the linear fitting line of FIG. 13. That is, the expected energy usage can be calculated as the gradient of the fitting line multiplied by the normalised integral value of aerosolisation session heating profile, plus a constant.

To summarise, at step 1006 of FIG. 10, the controller can apply incremental (i.e., stepwise) modifications to the aerosolisation session heating profile by adjusting the heating steps of the heating profile. The controller can then calculate the integral of the modified aerosolisation session heating profile, and normalise the integral value. The controller can then use a look-up or predetermined relationship to determine the expected energy use in an aerosolisation session using modified aerosolisation session heating profile, and determine how many aerosolisation sessions can be performed based upon measured battery level using this modified aerosolisation session heating profile. When the number of aerosolisation sessions that can be performed is not a+b (i.e., it is a) subsequent modifications can be made to the aerosolisation session heating profile until it is determined that a+b aerosolisation sessions can be performed. When the number of aerosolisation sessions that can be performed is a+b, the modified aerosolisation session heating profile is used as the second aerosolisation profile for the eco-mode.

In an alternative, rather than normalising the integral value of the aerosolisation session heating profile, a look-up table of predetermined values of expected energy usage for different modified aerosolisation session heating profiles can be used.

At step 1008, the controller controls the aerosol generation device to perform an aerosolisation session using the second aerosolisation session heating profile at which a+b aerosolisation sessions can be performed.

In this way, through modifying the aerosolisation session heating profile, a+b sessions can be performed for a given energy level in the battery, rather than only a sessions.

The controller can be further configured to control the aerosol generation device to output an indication that the aerosol generation device has entered the eco-mode.

In some examples, the aerosol generation device can include a display screen and outputting the indication that the aerosol generation device has entered the eco-mode can comprise displaying an indication on such a screen.

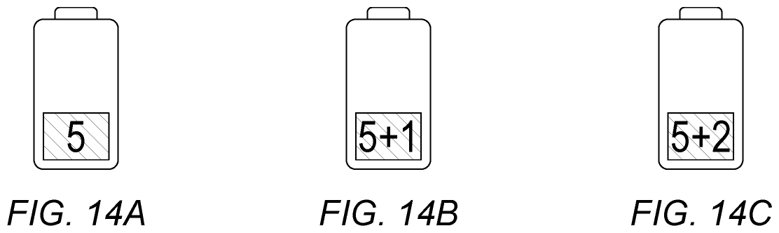

FIG. 14A shows an exemplary indication that can be output on the display screen when the aerosol generation device is operating in the normal mode (i.e., not operating in the eco-mode). In this example, a=5, and so “5” is displayed. FIG. 14B shows an exemplary indication that can be output on the display screen when the aerosol generation device is operating in a first eco-mode in which b=1. In this example a=5 and b=1, and so “5+1” is displayed. That is, the indication presents the number of sessions that can be powered in the normal operating mode (a), and the additional number of sessions that can be powered due to the eco-mode having been triggered (b). Likewise, FIG. 14C shows an exemplary indication that can be output on the display screen when the aerosol generation device is operating in a second eco-mode in which b=2. In this example a=5 and b=2, and so “5+2” is displayed. Whilst in the examples, values of a=5 and b=1, or b=2, have been used, the skilled person would readily understand that other suitable numbers that represent the number of available aerosolisation sessions can be displayed instead.

In other examples, the aerosol generation device could be paired to an external device such as a smartphone, for example by a wireless connection such as Bluetooth, or a wired connection through a physical interface; in such examples the outputting the indication that the aerosol generation device has entered the eco-mode can comprise transmitting data corresponding to the eco-mode being triggered to the external device, and the external device can then be used to indicate that the aerosol generation device has entered the eco-mode in a similar manner to FIGS. 14A-C.

In some examples, the controller can be configured such that the eco-mode is only triggerable when the aerosol generation device battery is capable of powering a number of aerosolisation sessions that is at or below a threshold number of sessions. In an example, the threshold may be five sessions. In this way, the operator cannot unnecessarily enter the eco-mode thereby preventing the operator from unnecessarily decreasing the quality of the aerosolisation session.

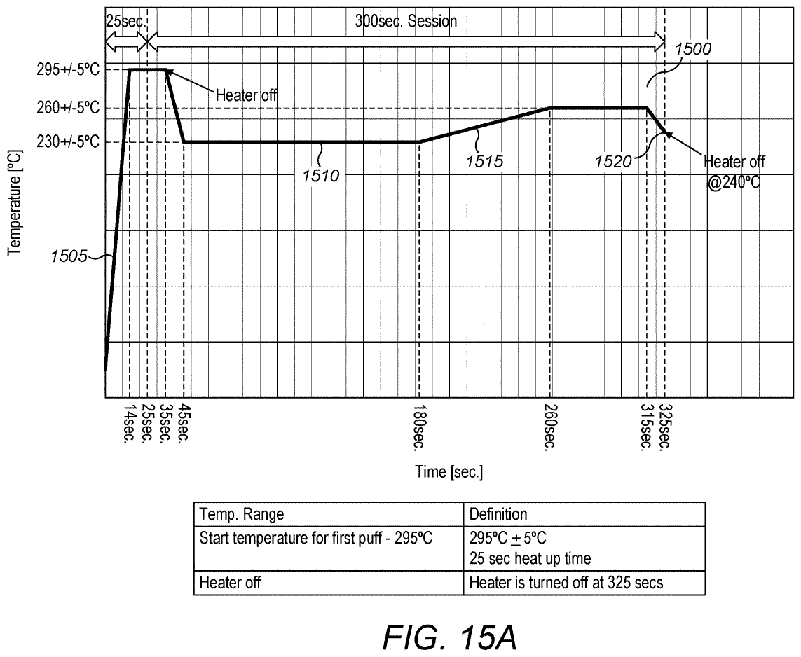

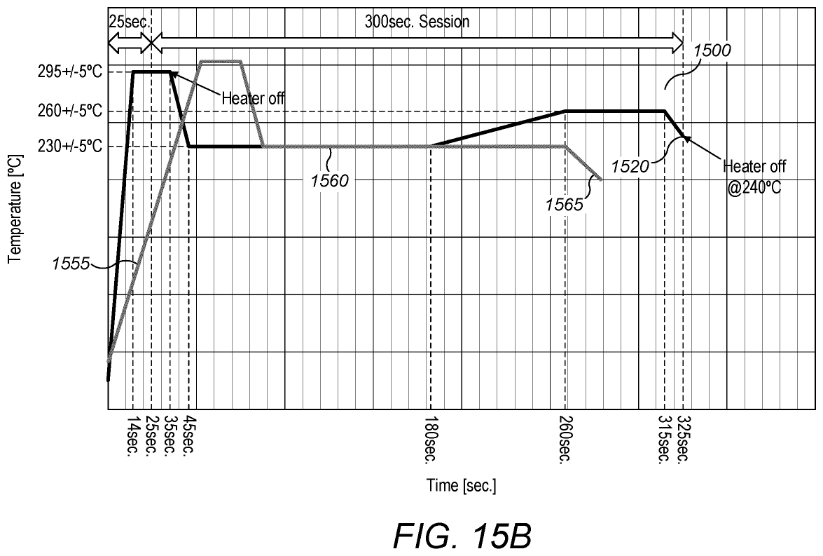

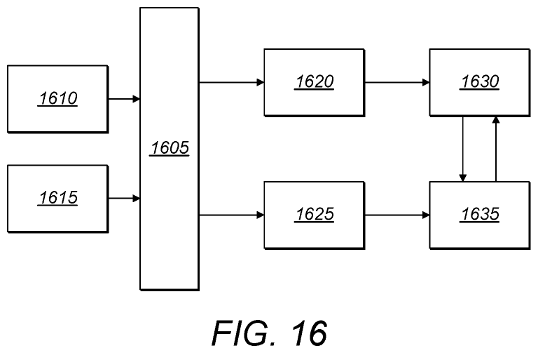

FIG. 15A shows an exemplary heating profile 1500 for a normal/standard operating mode. At the start of an aerosolisation session in the standard operating mode, the heater of the device is in a heat-up phase 1505 and preheated to reach a start temperature of 295 °C+5 °C over a time period of approximately 14 to 25 seconds. The aerosolisation session then lasts for a period of approximately 300 seconds, in which the heater is brought to and held in a first vaping phase 1510 at an operating temperature of 230 °C+5 °C for around half of the session (e.g. 150 to 180 seconds or so). In a second vaping phase 1515 in the latter half of the session, the heater temperature is increased to 260 °C+5 °C over a period of around 80 seconds and held at that temperature for a further 50 to 60 seconds before the heater is turned off at the end 1520 of the session.

In this standard operating mode, the working assumption is that a power of 20 W is needed for 15 seconds of the heating-up/preheating phase (which comes to 300 J of energy). If the time period of the preheating phase is extended to 30 seconds, i.e. doubled, then the required power is halved to 10 W (to provide the same amount of energy, 300 J). 10 W for 3.3 V battery means requires a current of around 3 A and a voltage drop of around 0.15 V. For 20 W, the required current and effective voltage drop is doubled, i.e. a current of 6 A and a voltage drop of 0.3 V. It has therefore been considered that a device battery can be used for a higher number of sessions by lowering the power requirement from the battery and extending a heat-up or preheating time.

FIG. 15B shows another exemplary graph with the heating profile 1500 for the first standard operating mode (described in FIG. 15A) as well as a second heating profile 1550 for an eco-mode or low power mode. The second heating profile 1550 has an extended heat-up phase 1555 where the heater is preheated to a start temperature of 295 °C+5 °C over a time period of approximately 45 to 55 seconds. The aerosolisation session of the eco-mode lasts for a shorter period than the standard operating mode for approximately 210 seconds (i.e. around 90 seconds less than the standard operating mode). This aerosolisation session may also only include a single vaping phase 1560 in which the heater is brought to and held at an operating temperature of 230 °C±5 °C for the duration of the aerosolisation session (e.g. 210 seconds or so). As will be appreciated, the aerosolisation session may also include different vaping phases and temperatures according to design requirements. At the end 1565 of the eco-mode aerosolisation session, the heater is turned off.

As an example, if 1000 J of energy is required for a vaping session of 270 seconds, shortening the session by 90 seconds will save around one third on the energy requirements, i.e. around 333 J. This means that a device battery run on a low power/eco-mode will increase the number of consumable sticks that can be aerosolised with the remaining state-of-charge or remaining amount of energy in the battery. The device may be run automatically on the eco-mode when the remaining power in the battery reaches a predetermined threshold amount, e.g. 10% of remaining state-of-charge or remaining amount of energy. Alternatively, a user may manually switch the device from a standard operating mode to a low power eco-mode at any time/any battery level to increase the number of aerosolisation sessions. Such energy and power savings allow a device battery to be smaller or have a smaller energy content or energy density.

FIG. 16 shows a controls schematic of an aerosol generation device according to the present disclosure. The device comprises a controller 1605 in communication with a battery 1610 and a heater 1615. The controller 1605 may be a multipoint control unit and the heater 1615 may be a negative temperature coefficient heater.

The controller 1605 adjusts a maximum power drawn from the battery 1610 and controls the heater 1615 by using a battery observer 1620 and a heater observer 1625. The battery observer 1620 allows the controller 1605 to read state-of-charge, state-of-health, remaining amount of energy and battery temperature information from the battery 1610. The heater observer 1625 allows the controller to read heater temperature, battery current, and battery voltage information from the heater 1615. Using the information from the battery observer 1620 and the heater observer 1625, the controller 1605 may determine or select a battery model 1630 for the battery 1610 and a heater model 1635 for the heater 1615, where the respective models include specific parameters to operate the battery/heater. In this way, different operating profiles with different parameters may be implemented until the battery 1610 is fully depleted and an optimal number of aerosolisation sessions is provided to a user.

Information provided by the battery model 1630 allows the controller 1605 to operate the battery 1610 in an eco-or low power mode. The information may be in form of an estimated minimum voltage during a session and/or a number of sessions that can be sustained by the battery 1610 according to a given temperature profile/load profile (from a heater model) without reaching a minimum voltage threshold set by the controller 1605. The eco-or low power modes(s) may have further sub-modes or settings where the controller 1605 may operate the device using a gradual power reduction mode or a constant mode to ensure that a given number of consumable sticks/aerosolisation sessions can be consumed per full charge of the battery 1610.

In the gradual power/energy consumption reduction setting, the period of time of the pre-heating phase may be gradually increased as the state-of-charge or remaining amount of energy of the battery 1610 decreases. For example, the pre-heating time may be 25 seconds in a first eco-mode aerosolisaiton session in the gradual reduction setting, followed by 30 seconds in a second session, 35 seconds in a third session, 40 seconds in a fourth session and 45 seconds in a fifth session. Alternatively, in the constant mode setting of a low power mode, the pre-heating phase may have a constant time period of 35 seconds, for example. As will be appreciated, increasing a pre-heating time lowers the power requirements from the battery 1610, which in turn ensures that the output of the battery 1610 does not to reach a minimum voltage threshold set by the controller 1605 (since an elevated power output may be required during the pre-heating phase) and thus allow the battery 1610 to able to sustain greater number of aerosolisation sessions.

Whilst the foregoing examples of the processes described with reference to FIGS. 3, 6, 9 and 10 have been described in the context of an aerosol generation device configured to aerosolise an aerosol generating consumable such as a tobacco rod containing tobacco, the teaching can equally be applied to ‘e-vapour’ type aerosol generation devices in which a liquid based aerosol generating material is vapourised or aerosolised, for example using a wicking material and heater. In such examples, an aerosolisation session can be considered as one ‘puff’. The teaching can also be applied to aerosol generation devices configured to generate a single puff by heating tobacco.

In the preceding examples, the processing steps described herein carried out by the controller may be stored in a non-transitory computer-readable medium, or storage, associated with the controller. A computer-readable medium can include non-volatile media and volatile media. Volatile media can include semiconductor memories and dynamic memories, amongst others. Non-volatile media can include optical disks and magnetic disks, amongst others.

It will be readily understood to the skilled person that the preceding embodiments in the foregoing description are not limiting; features of each embodiment may be incorporated into the other embodiments as appropriate.

1. An aerosol generation device comprising:
a battery;
a battery monitor; and
a controller, wherein the controller is configured to:
measure an energy level of the battery using the battery monitor;
calculate a number, a, of aerosolisation sessions that can be powered based upon the measured energy level of the battery and an expected energy usage per session for a first aerosolisation session heating profile, wherein a is an integer greater than or equal to 0, and a heating profile comprises one or more heating steps wherein each of the one or more heating steps corresponds to heating a heater of the aerosol generation device to a predetermined target heater temperature value for a predetermined period of time;
receive an instruction to enter an eco-mode in which a+b aerosolisation sessions can be performed, wherein b is an integer greater than or equal to 1, wherein an aerosolisation session in the eco-mode uses less energy of the battery than an aerosolisation session not in the eco-mode;
in response to the instruction to enter the eco-mode, incrementally modify the aerosolisation session heating profile and recalculate the number of aerosolisation sessions that can be powered based upon the measured energy level of the battery and an expected energy usage per session for each of the incrementally modified aerosolisation session heating profiles until a second aerosolisation session heating profile is determined at which a+b aerosolisation sessions can be performed; and
control the aerosol generation device to perform an aerosolisation session using the second aerosolisation session heating profile at which a+b aerosolisation sessions can be performed.

2. The aerosol generation device of claim 1, wherein incrementally modifying the aerosolisation session heating profile and recalculating the number of aerosolisation sessions that can be powered based upon the measured energy level of the battery and an expected energy usage per session for each of the incrementally modified aerosolisation session heating profiles until a second aerosolisation session heating profile is determined at which a+b aerosolisation sessions can be performed comprises, in a loop:
modifying the aerosolisation session heating profile with an incremental modification to a modified aerosolisation session heating profile;
determining an expected energy usage of an aerosolisation session with the modified aerosolisation session heating profile; and
determining the number of aerosolisation sessions that can be powered based upon the expected energy usage for an aerosolisation session with the modified aerosolisation session heating profile;
wherein the loop continues until a modified aerosolisation session heating profile is determined at which the number of aerosolisation sessions that can be powered based upon the expected energy usage for an aerosolisation session with the modified aerosolisation session heating profile is a+b; and
the controller is configured to designate the modified aerosolisation session heating profile at which a+b aerosolisation sessions can be performed as the second aerosolisation session heating profile.

3. The aerosol generation device of claim 2, wherein determining an expected energy usage of an aerosolisation session with the modified aerosolisation session heating profile comprises:
determining an integrated aerosolisation session heating profile value for the modified aerosolisation session heating profile by integrating the target heater temperature values as a function of time in the modified aerosolisation session heating profile; and
determining an expected energy usage of an aerosolisation session performed using the modified aerosolisation session heating profile based upon a predetermined relationship between integrated aerosolisation session heating profile values and expected energy usage in aerosolisation sessions.

4. The aerosol generation device of claim 3, wherein determining an expected energy usage of an aerosolisation session with the modified aerosolisation session heating profile further comprises:
normalising the determined integrated aerosolisation session heating profile value to determine a normalised integrated aerosolisation session heating profile value; and
wherein the expected energy usage of an aerosolisation session performed using the modified aerosolisation session heating profile is determined based upon a predetermined relationship between normalised integrated aerosolisation session heating profile values and expected energy usage in aerosolisation sessions.

5. The aerosol generation device of claim 1, wherein incrementally modifying the aerosolisation session heating profile comprises incrementally reducing a target heater temperature in the aerosolisation session heating profile, and/or incrementally adjusting a length of time of the aerosolisation session heating profile.

6. The aerosol generation device of claim 1, wherein the one or more heating steps is plurality of heating steps.

7. The aerosol generation device of claim 6, wherein each incremental modification to the aerosolisation heating profile comprises a predetermined modification to one or more of the plurality of heating steps.

8. The aerosol generation device of claim 7, wherein each predetermined modification to the one or more of the plurality of heating steps comprises a predetermined reduction in the target heater temperature of one or more of the heating steps or a predetermined adjustment to the period of time of one or more of the heating steps.

9. The aerosol generation device of claim 7, wherein the incremental modifications have a predetermined order of preference; and modifying the aerosolisation session heating profile comprises applying the incremental modifications in the order of preference until the second aerosolisation session heating profile is determined at which a+b aerosolisation sessions can be performed.

10. The aerosol generation device of claim 1, wherein the first aerosolisation session heating profile is that of a normal operating mode of the aerosol generation device.

11. The aerosol generation device of claim 1, wherein an aerosolisation session performed using the second aerosolisation session heating profile uses less energy of the battery than the first aerosolisation session heating profile.

12. The aerosol generation device of claim 1, wherein b=1 or 2.

13. The aerosol generation device of claim 1, wherein the controller is further configured to control the aerosol generation device to output an indication that the eco-mode has been initiated.

14. A method of operating an aerosol generation device comprising a battery, a controller and a battery monitor, wherein the method comprises:
measuring, with the controller, an energy level of the battery using the battery monitor;
calculating, with the controller, a number, a, of aerosolisation sessions that can be powered based upon the measured energy level of the battery and an expected energy usage per session for a first aerosolisation session heating profile, wherein a is an integer greater than or equal to 0, and a heating profile comprises one or more heating steps wherein each of the one or more heating steps corresponds to heating a heater of the aerosol generation device to a predetermined target heater temperature value for a predetermined period of time;
receiving, at the controller, an instruction to enter an eco-mode in which a+b aerosolisation sessions can be performed, wherein b is an integer greater than or equal to 1, wherein an aerosolisation session in the eco-mode uses less energy of the battery than an aerosolisation session not in the eco-mode;
in response to the instruction to enter the eco-mode, incrementally modifying, with the controller, the aerosolisation session heating profile and recalculating the number of aerosolisation sessions that can be powered based upon the measured energy level of the battery and an expected energy usage per session for each of the incrementally modified aerosolisation session heating profiles until a second aerosolisation session heating profile is determined at which a+b aerosolisation sessions can be performed; and
controlling, with the controller, the aerosol generation device to perform an aerosolisation session using the second aerosolisation session heating profile at which a+b aerosolisation sessions can be performed.

15. A non-transitory computer-readable medium storing instructions executable by one or more processors of an aerosol generation device comprising a battery, a controller and a battery monitor cause the one or more processors to perform steps comprising:
measuring, with the controller, an energy level of the battery using the battery monitor;
calculating, with the controller, a number, a, of aerosolisation sessions that can be powered based upon the measured energy level of the battery and an expected energy usage per session for a first aerosolisation session heating profile, wherein a is an integer greater than or equal to 0, and a heating profile comprises one or more heating steps wherein each of the one or more heating steps corresponds to heating a heater of the aerosol generation device to a predetermined target heater temperature value for a predetermined period of time;
receiving, at the controller, an instruction to enter an eco-mode in which a+b aerosolisation sessions can be performed, wherein b is an integer greater than or equal to 1, wherein an aerosolisation session in the eco-mode uses less energy of the battery than an aerosolisation session not in the eco-mode;
in response to the instruction to enter the eco-mode, incrementally modifying, with the controller, the aerosolisation session heating profile and recalculating the number of aerosolisation sessions that can be powered based upon the measured energy level of the battery and an expected energy usage per session for each of the incrementally modified aerosolisation session heating profiles until a second aerosolisation session heating profile is determined at which a+b aerosolisation sessions can be performed; and
controlling, with the controller, the aerosol generation device to perform an aerosolisation session using the second aerosolisation session heating profile at which a+b aerosolisation sessions can be performed.
